(19) United States
(12) Patent Application Publication
(10) Pub. No.: US 2020/0242689 A1
(43) Pub. Date: Jul. 30, 2020

(54) SYSTEMS, METHODS, AND STORAGE MEDIA FOR SUBMITTING A RENTAL APPLICATION

(71) Applicant: TurboTenant, Inc., Fort Collins, CO (US)

(72) Inventor: Sarnen Steinbarth, Fort Collins, CO (US)

(21) Appl. No.: 16/776,800

(22) Filed: Jan. 30, 2020

Related U.S. Application Data
(60) Provisional application No. 62/798,650, filed on Jan. 30, 2019.

(51) Int. Cl. G06Q 40/02; G06Q 30/00; G06Q 20/14

(52) U.S. Cl. CPC G06Q 40/025; G06Q 20/14; G06Q 30/0185

(57) ABSTRACT

Systems, methods, and storage media for submitting a rental application are disclosed. Exemplary implementations may: provide user identifying information, user income information, and/or user background information from a user to the rental platform; pay an application fee and proactively approve a credit and background check from the user on the rental platform prior to a landlord requesting the approval; send credit and background check information to a consumer credit reporting agency, and receive, at the rental platform, a plurality of questions from the consumer credit reporting agency; provide a plurality of answers from the user to the consumer credit reporting agency via the rental platform in response to the questions; inform the user the application is complete; receive at the rental platform a response from the consumer credit reporting agency; and enable the landlord to access the user's credit history.

### PRIORITY AND CROSS REFERENCE TO RELATED APPLICATIONS

The present Application for Patent claims priority to Provisional Application No. 62/798,650, titled “Systems, Methods, and Storage Media for Submitting a Rental Application”, filed Jan. 30, 2019, and assigned to the assignee hereof. This application is hereby expressly incorporated by reference herein.

### FIELD OF THE DISCLOSURE

The present disclosure relates to systems, methods, and storage media for submitting a rental application.

### BACKGROUND

Current processes in submitting rental applications include several inefficiencies, such as one or more wait states between different processes (i.e., submitting initial application, requesting further applicant information, authorizing background/credit check, receiving results of background/credit check, and final decision by the landlord). In some instances, these wait states lead to a significant duration of time (e.g., 2 or more weeks) between when an applicant submits a rental application and receives a final decision regarding the same from the landlord, resulting in uncertainty and stress for the applicant. Further, current techniques for managing rental properties, including posting listings, communicating with current and future tenants, tenant screening, receiving references, etc., are cumbersome and often times require setting up accounts with multiple online platforms.

Current techniques for submitting rental applications also involve significant back and forth communication between rental property managers or landlords and potential tenants. For instance, a typical process may include filing of an initial rental application by the potential tenant and reviewal of the same by the landlord. In most cases, landlords may not have a convenient one-stop online rental portal setup, and potential tenants may need to fill out paper forms. In other cases, for instance, when landlords do have online rental portals, potential tenants may need to create different online accounts for each landlord's properties they are applying to, which is highly inconvenient for potential tenants. Furthermore, such online portals often lack security features, especially with regards to personal information (e.g., Social Security Number) provided by the applicant.

Following an initial review, the landlord may contact the potential tenant for additional information, including income information and authorization for the landlord to proceed with a background check and/or credit check. In some cases, the landlords and potential tenants may endure significant times for these checks, since companies performing background and credit checks may take up to 1-2 weeks to return the results to the landlord. After reviewing the results, the landlord can make a final decision (i.e., moving in or not moving in) on the potential tenant's rental application.

As described above, applicants or potential tenants for a rental property may endure significant wait times after submitting a rental application and waiting for a final decision from the landlord. Further, potential tenants may need to fill out paper forms or create different login accounts for each landlord's properties they are applying to. For instance, a potential tenant may need to create a first user-name and password for a first online portal while submitting an application for a property A owned by landlord A, a second user-name and password for a second online portal while submitting another application for a property B owned by landlord B, and so on. Further, the potential tenant may need to enter their personal information (e.g., name, date of birth, previous address information, references, income information, etc.) on each online rental portal they are applying on. Besides the redundancy in entering personal information, some online portals lack security features to adequately protect the applicant's personal information. In some instances, besides the nuisance for the applicant, security breaches may also lead to financial loss (e.g., lawsuits) and reputational damage for the landlord.

Thus, current techniques for managing rental properties and submitting rental applications are not only cumbersome and inefficient, but also fail to adequately inform potential tenants about the status of their future living situation.

### SUMMARY OF THE DISCLOSURE

In order to address the deficiencies in the current techniques, disclosed herein are systems, methods, and storage media for submitting rental applications, as well as providing speedy and informed suggestions and decisions to both landlords and users (i.e., potential tenants) alike to enhance their experience. It should be noted that the terms user, potential tenant, or applicant may be used interchangeably throughout this application. Further, the terms landlords, property manager, or rental property manager may also be used interchangeably throughout this application. Lastly, for the purposes of this disclosure, consumer credit reporting agency and credit bureau may be used interchangeably.

The present disclosure is generally directed to easing the rental application process for both users and landlords. Specifically, aspects of the present disclosure enable users to submit rental applications, including providing answers to background check and consumer credit reporting agencies. Furthermore, the present disclosure allows users to receive timely updates on the status of their rental application, and proactively pre-approve credit and background checks for the user. In some embodiments, the present disclosure also enhances the landlord's ability to manage their rental properties, including posting their properties on one or more third-party rental listing websites, receiving references from potential tenants, or receiving information pertaining to a potential tenant's credit score, criminal history, and/or past evictions (also referred to as screening). In some cases, the landlord may also utilize the rental platform system of the present disclosure to communicate with their current and potential tenants.

One aspect of the present disclosure relates to a system configured for submitting a rental application. The system may include one or more hardware processors configured by machine-readable instructions. The processor(s) may be configured to provide user identifying information from a user to a rental platform. The processor(s) may be configured to provide user income information from a user to the rental platform. The processor(s) may be configured to provide user background information from a user to the rental platform. The processor(s) may be configured to pay an application fee on the rental platform. The processor(s) may be configured to proactively approve a credit and background check from the user on the rental platform prior to a landlord requesting the approval. The processor(s) may be configured to send information related to the credit and background check from the rental platform to a consumer credit reporting agency. The processor(s) may be configured to receive at the rental platform a plurality of questions from the consumer credit reporting agency. The processor(s) may be configured to send the plurality of questions from the rental platform to the user. The processor(s) may be configured to provide a plurality of answers in response to the plurality of questions from the user to the rental platform. The processor(s) may be configured to send the plurality of answers from the rental platform to the consumer credit reporting agency. The processor(s) may be configured to inform the user the application is complete. The processor(s) may be configured to receive at the rental platform a response from the consumer credit reporting agency. The response may include information related to the user's credit history. The processor(s) may be configured to enable the landlord to access the information related to the user's credit history.

Another aspect of the present disclosure relates to a method for submitting a rental application. The method may include providing user identifying information from a user to a rental platform. The method may include providing user income information from a user to the rental platform. The method may include providing user background information from a user to the rental platform. The method may include paying an application fee on the rental platform. The method may include proactively approving a credit and background check from the user on the rental platform prior to a landlord requesting the approval. The method may include sending information related to the credit and background check from the rental platform to a consumer credit reporting agency. The method may include receiving at the rental platform a plurality of questions from the consumer credit reporting agency. The method may include sending the plurality of questions from the rental platform to the user. The method may include providing a plurality of answers in response to the plurality of questions from the user to the rental platform. The method may include sending the plurality of answers from the rental platform to the consumer credit reporting agency. The method may include informing the user the application is complete. The method may include receiving at the rental platform a response from the consumer credit reporting agency. The response may include information related to the user's credit history. The method may include enabling the landlord to access the information related to the user's credit history.

Yet another aspect of the present disclosure relates to a non-transient computer-readable storage medium having instructions embodied thereon, the instructions being executable by one or more processors to perform a method for submitting a rental application. The method may include providing user identifying information from a user to a rental platform. The method may include providing user income information from a user to the rental platform. The method may include providing user background information from a user to the rental platform. The method may include paying an application fee on the rental platform. The method may include proactively approving a credit and background check from the user on the rental platform prior to a landlord requesting the approval. The method may include sending information related to the credit and background check from the rental platform to a consumer credit reporting agency. The method may include receiving at the rental platform a plurality of questions from the consumer credit reporting agency. The method may include sending the plurality of questions from the rental platform to the user. The method may include providing a plurality of answers in response to the plurality of questions from the user to the rental platform. The method may include sending the plurality of answers from the rental platform to the consumer credit reporting agency. The method may include informing the user the application is complete. The method may include receiving at the rental platform a response from the consumer credit reporting agency. The response may include information related to the user's credit history. The method may include enabling the landlord to access the information related to the user's credit history.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIGS. 1A and 1B illustrate a system configured for submitting a rental application, in accordance with one or more implementations.

FIGS. 2A and 2B illustrate a method for submitting a rental application, in accordance with one or more implementations.

FIGS. 3A and 3B illustrate visualizations of a user interface for a user providing user information according to various embodiments of the disclosure.

FIG. 4 illustrates a visualization of a user interface for a user providing user information according to various embodiments of the disclosure.

FIGS. 5A, 5B, and 5C illustrates a visualization of a user interface for a user submitting a rental application according to various embodiments of the disclosure.

FIGS. 6A and 6B illustrate visualizations of a user interface for a user paying an application fee and pre-approving requests for credit and background checks, respectively, according to various embodiments of the disclosure.

FIG. 7 illustrates a visualization of a user interface for obtaining credit and background check information from a user according to various embodiments of the disclosure.

FIG. 8 illustrates an example of questions received from a consumer credit reporting agency and displayed on a user interface of the rental platform according to various embodiments of the disclosure.

FIG. 9 illustrates a visualization of a user interface for a user requesting a screening report according to various embodiments of the disclosure.

FIG. 10 illustrates an example of an email notifying a landlord of a new rental application.

FIG. 11 illustrates a visualization of a user interface for a landlord viewing a summary of the user's rental application according to various embodiments of the disclosure.

FIG. 12 illustrates a visualization of a user interface for a landlord waiting on receiving a screening report for the user according to various embodiments of the disclosure.

FIG. 13 illustrates a visualization of a user interface for a landlord viewing a screening report according to various embodiments of the disclosure.

FIG. 14 is a block diagram illustrating a computer system according to various embodiments of the disclosure.

### DETAILED DESCRIPTION

The words “for example” is used herein to mean “serving as an example, instant or illustration.” Any embodiment described herein as “for example” or any related term is not necessarily to be construed as preferred or advantageous over other embodiments. Additionally, a reference to a “device” or an “embodiment” is not meant to be limiting to a single such device or embodiment but is instead meant as a representative example. It is contemplated that numerous devices may comprise a single “device” as described herein.

In order to address the inefficiencies described above, a one-stop rental platform system was created to not only streamline how landlords find, screen, and manage their tenants, but also how potential tenants find their future living situation from a plurality of landlords, each listing a plurality of rental properties.

The Applicant's disclosure aims to alleviate some of the shortcomings of the current rental application experience through a digital transformation encompassing an end-to-end solution designed to meet both user (i.e., potential tenants) and landlord needs. Specifically, the system allows for integration of property listings from multiple landlords to a single platform, where a user may utilize the single platform for submitting rental applications to one or more landlords. Further, by virtue of utilizing a single platform, the system may serve to reduce or eliminate the need for a user to enter redundant information. In some aspects, the system also optimizes the length of time a user has to wait between submitting a rental application and receiving a decision from the landlord.

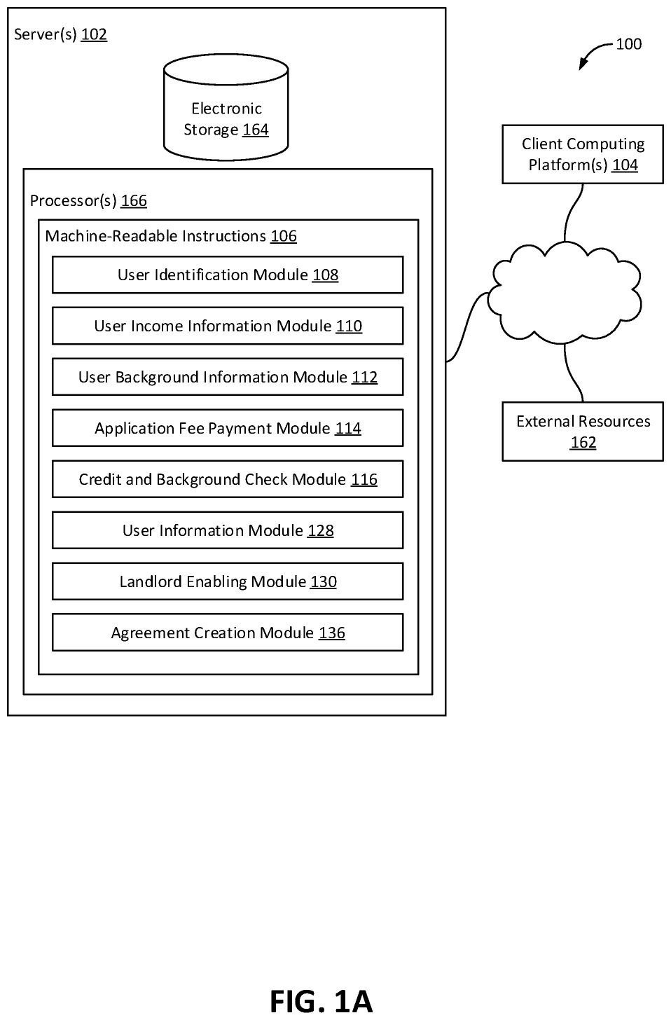

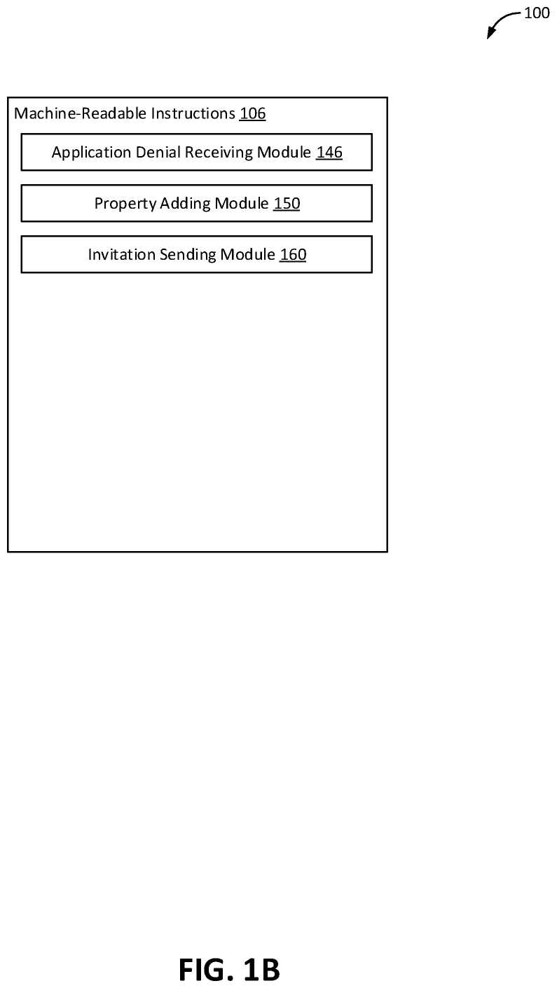

FIGS. 1A & 1B illustrate a system 100 configured for submitting a rental application, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. One user may comprise a prospective renter. In some examples, system 100 may also be referred to as a rental platform system. Further, users may access the system 100 or rental platform system via an app (e.g., a mobile app) running on (or accessed via) client computing platform(s) 104. In some cases, client computing platform(s) 104 may be an example of a network connected device, such as a smart phone, tablet, etc., further described below.

Server(s) 102 may be configured by machine-readable instructions 106. Machine-readable instructions 106 may include one or more instruction modules. The instruction modules may include computer program modules. The instruction modules may include one or more of a user identification module 108, a user income information module 110, a user background information module 112, an application fee payment module 114, a credit and background check module 116, a user information module 128, a landlord enabling module 130, an agreement creation module 136, an application denial receiving module 146, a property adding module 150, an invitation sending module 160, and/or other instruction modules.

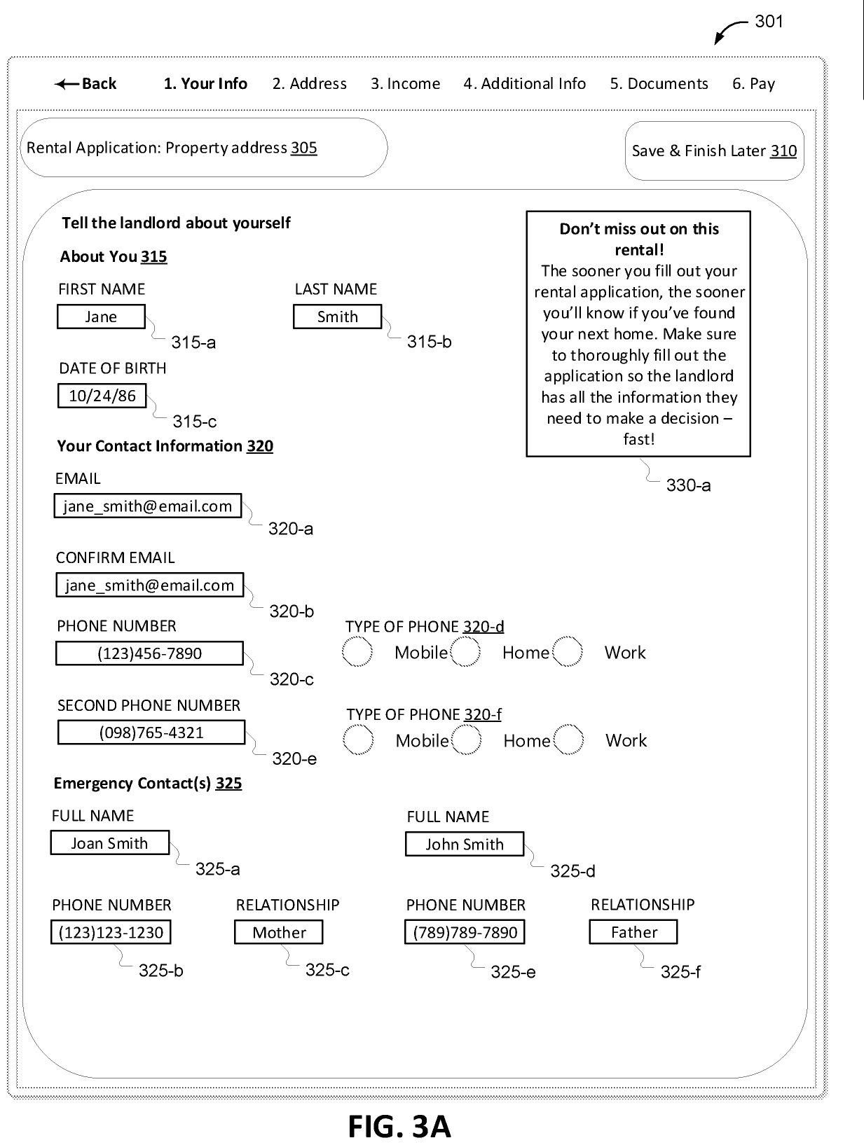

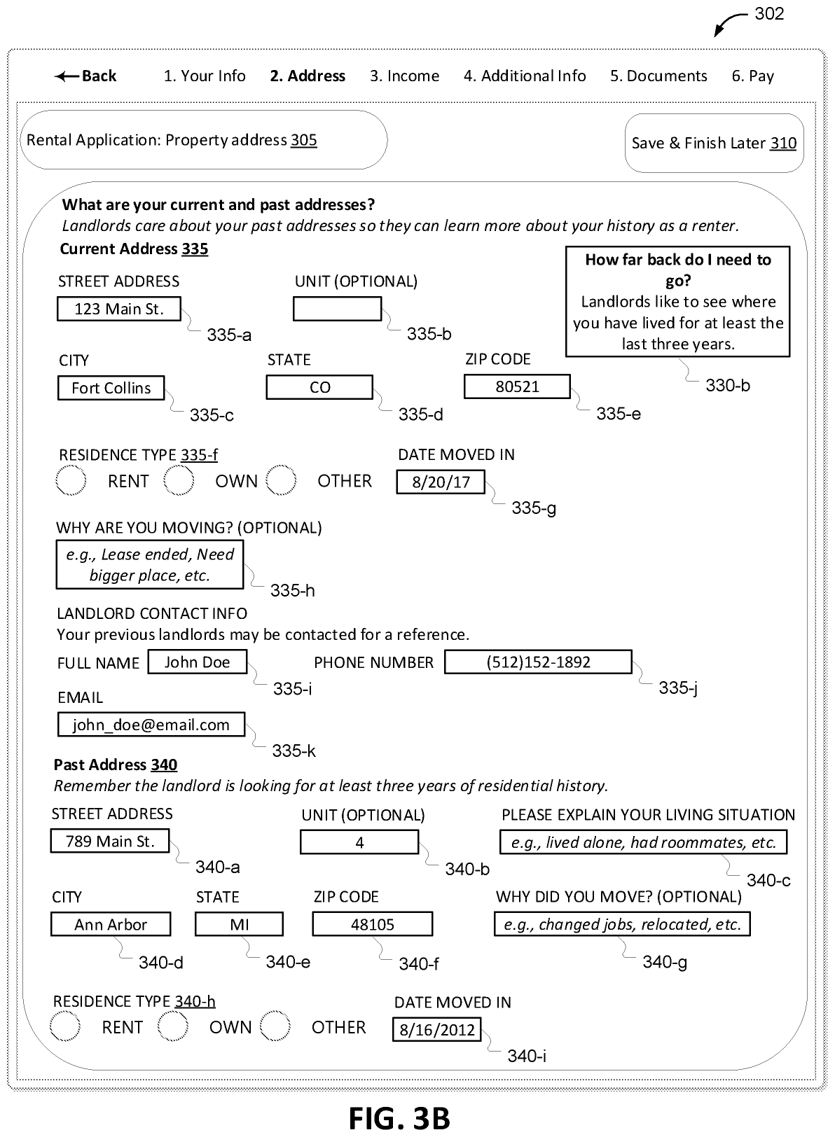

User identification module 108 may be configured to provide user identifying information from a user to a rental platform. Such identify information may comprise at least one of a current physical address, a past physical address, a name, an email address, and a phone number, as further illustrated and described in relation to FIGS. 3A & 3B.

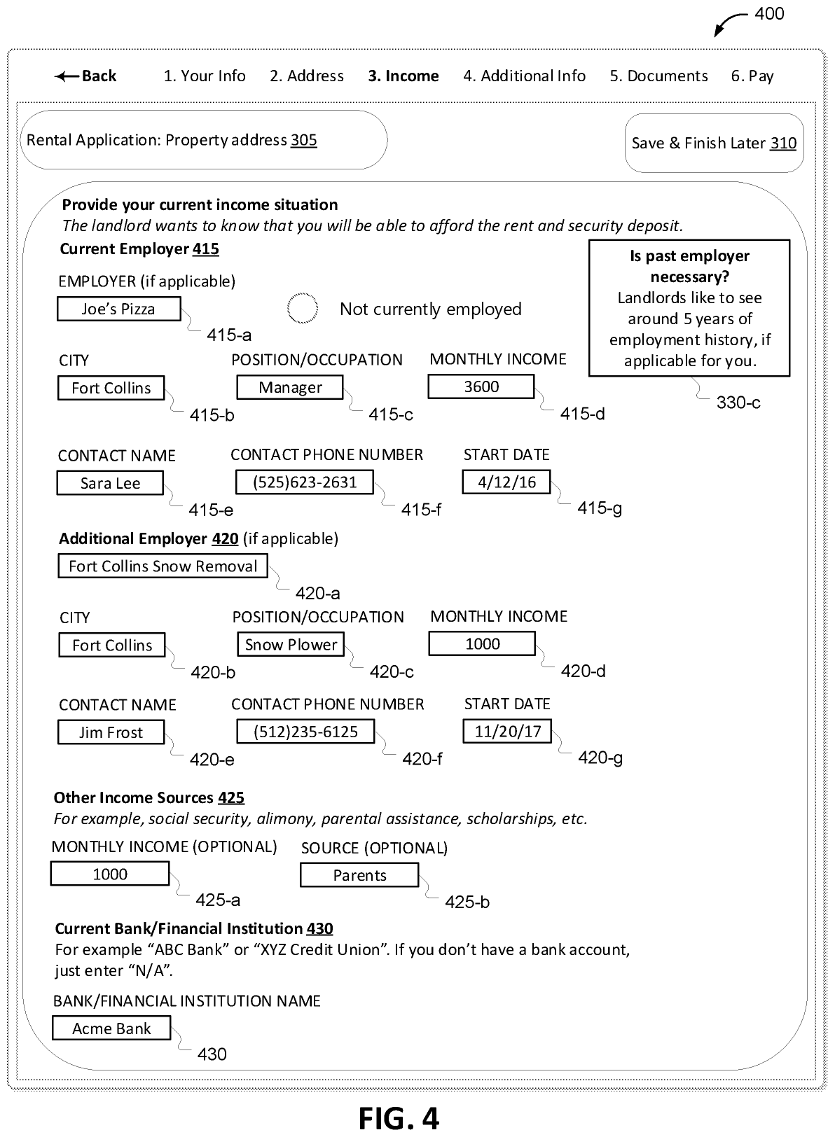

User income information module 110 may be configured to provide user income information from a user to the rental platform. By way of non-limiting example, income information may include at least one of, a name and location of a current employer, a job title, an income amount received from the current employer, a job start date, contact information for the current employer, an income amount received from an additional income source, and a current financial institution name, as further illustrated and described in relation to FIG. 4.

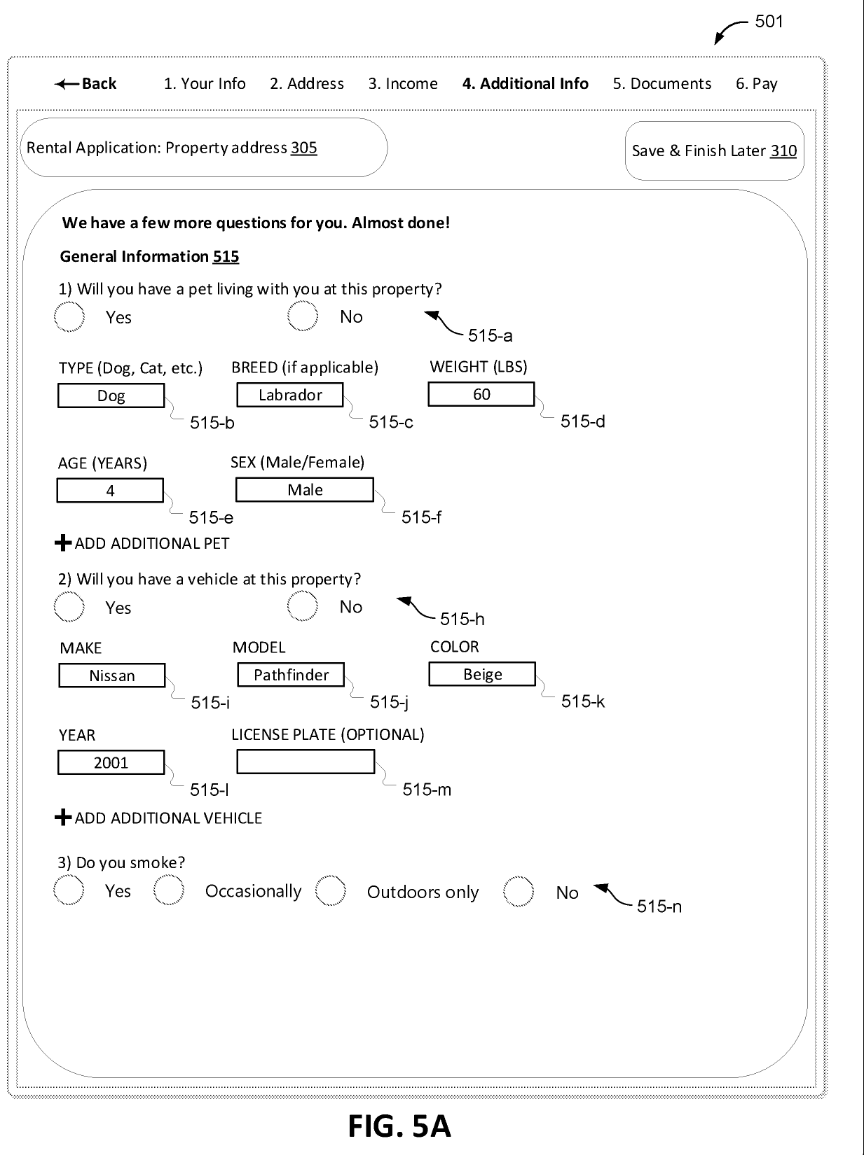

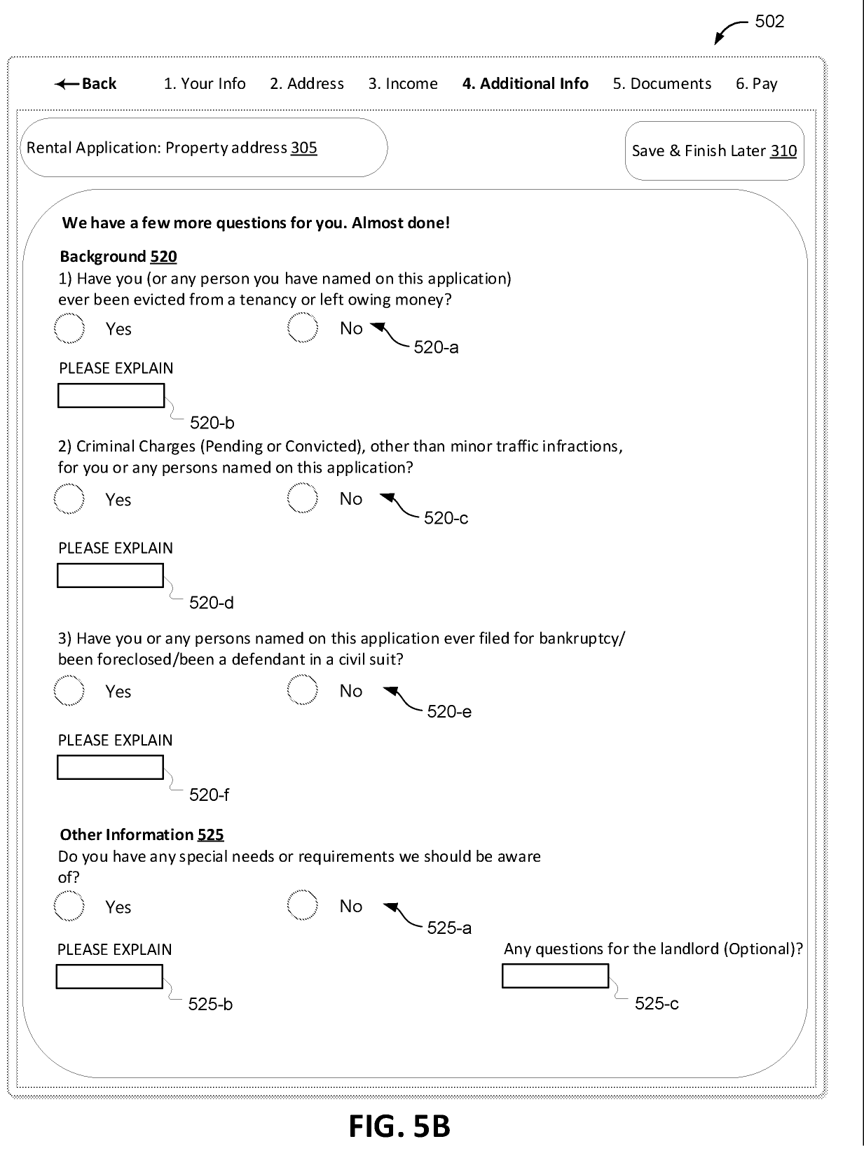

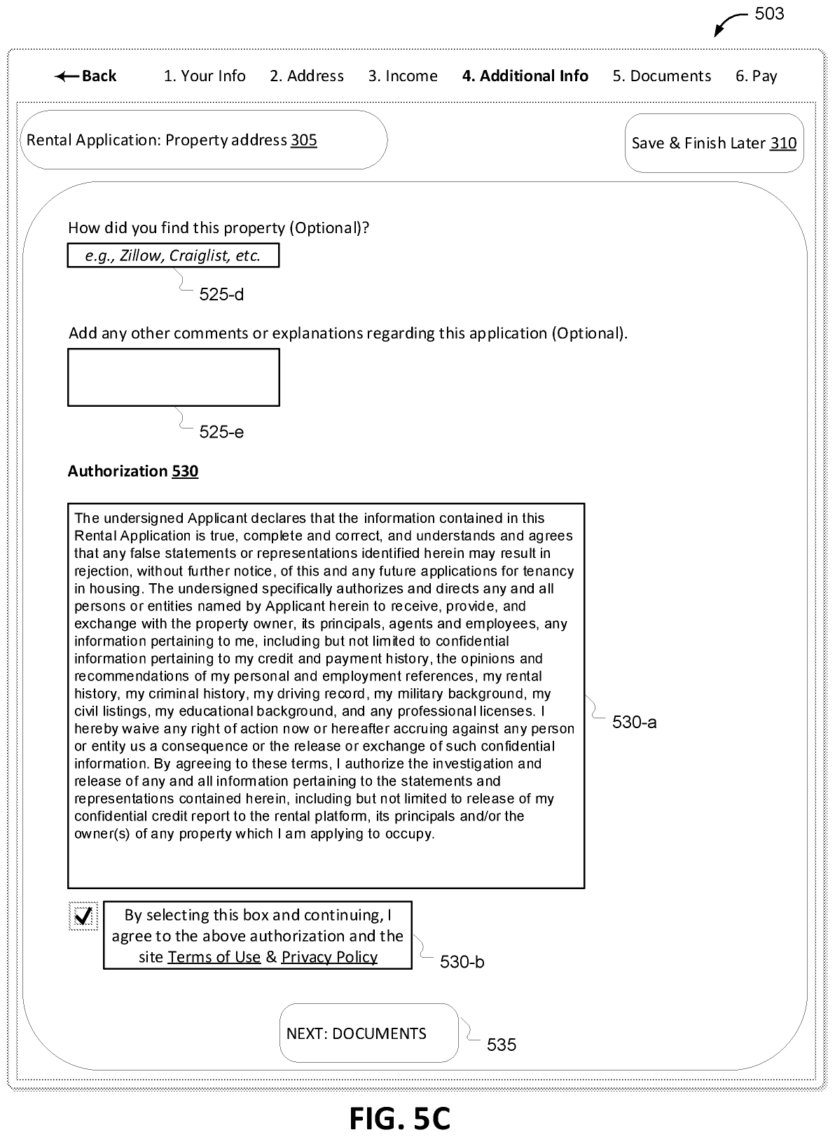

User background information module 112 may be configured to provide user background information from a user to the rental platform. By way of non-limiting example, background information may include at least one of information related to an eviction, information related to any criminal charges, and information related to a bankruptcy, as further illustrated and described in relation to FIGS. 5A-5C.

Application fee payment module 114 may be configured to pay an application fee on the rental platform, as further illustrated and described in relation to FIGS. 5A-5C.

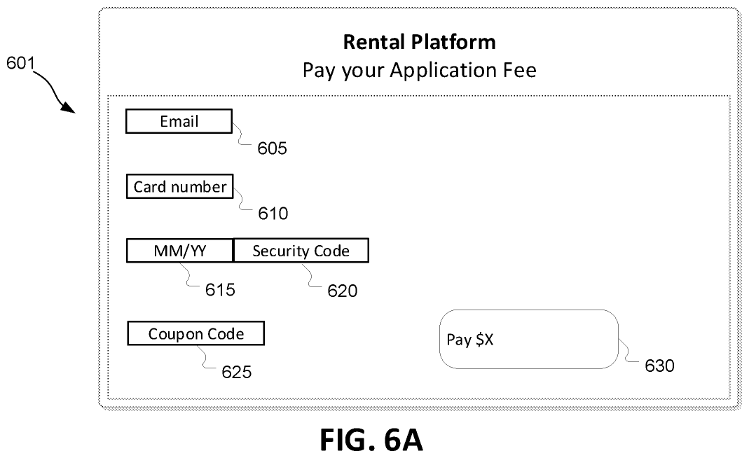

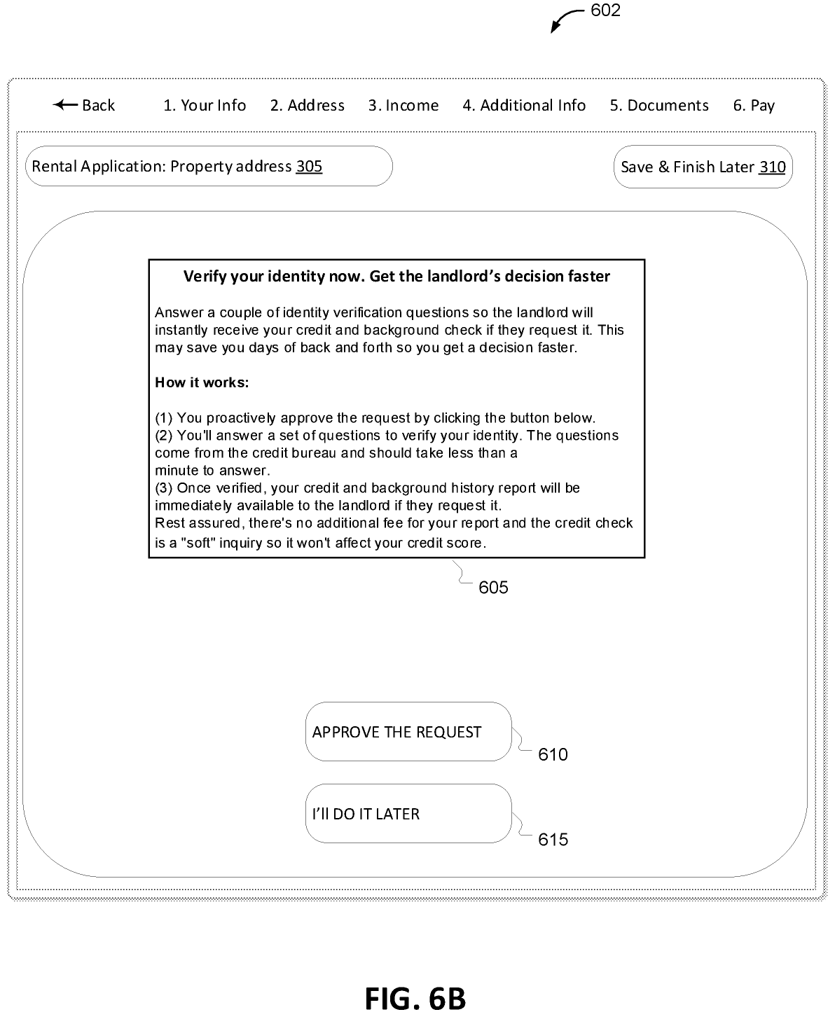

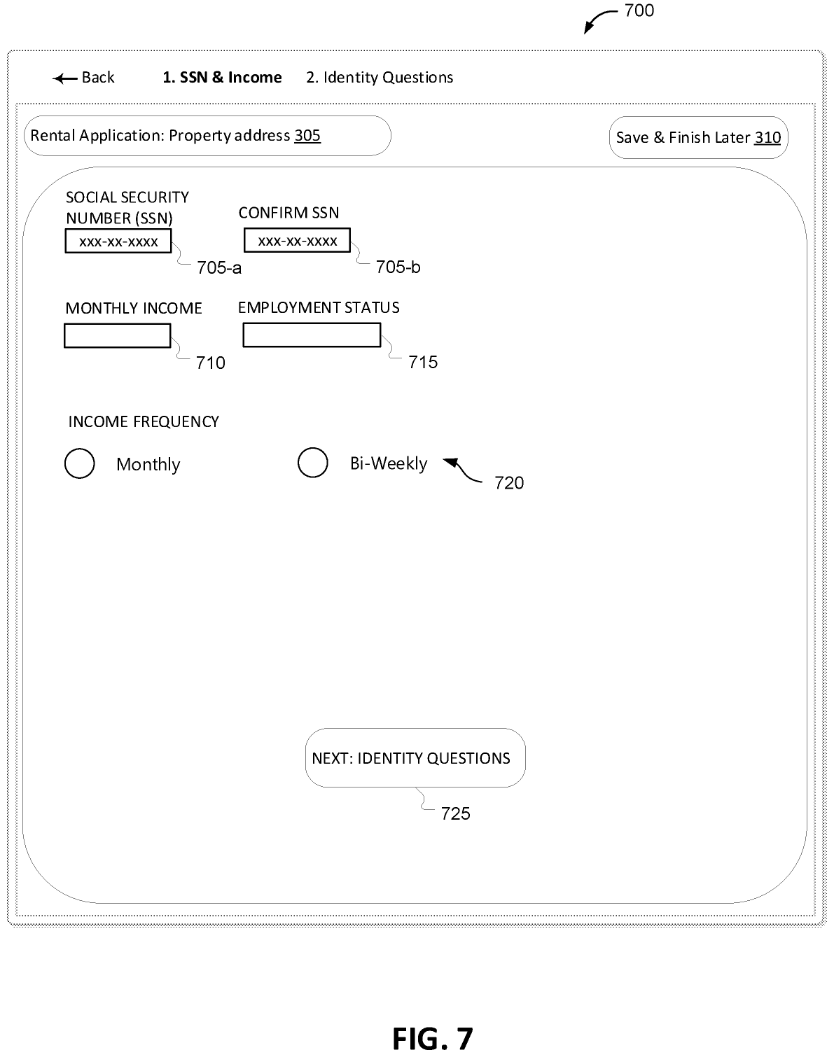

Credit background check module 116 may be configured for the user to proactively approve a credit and background check on the rental platform prior to a landlord requesting the approval. For instance, seen in FIG. 6 is one embodiment of a user interface for proactively approving a request to submit a credit and/or background check prior to the request being sent from the landlord to a consumer credit reporting agency. Upon approving the request, the credit and background check module 116 may be further configured to obtain information related to the credit and background check from the user and send the information from the rental platform to a consumer credit reporting agency, as further illustrated and described in relation to FIG. 7.

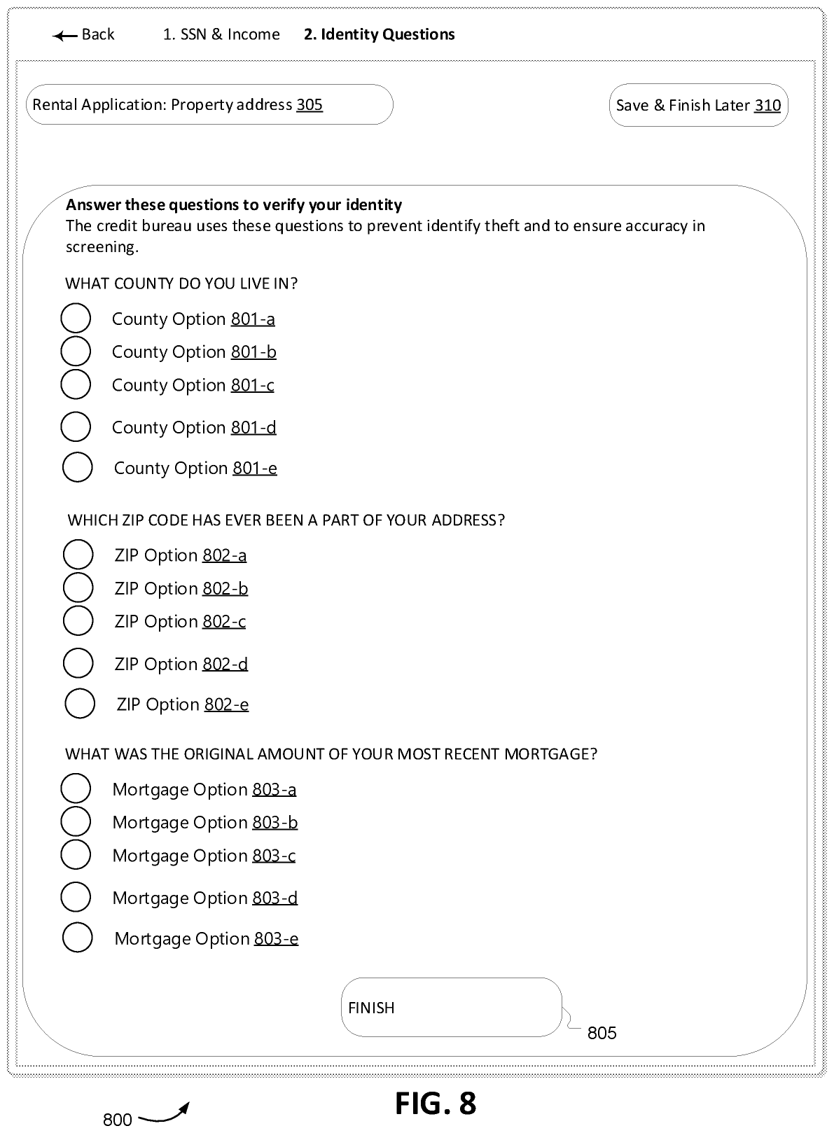

Upon providing the credit and background check information, the credit and background check module 116 may be further configured to receive at the rental platform a plurality of questions from the consumer credit reporting agency. The questions may include information related to the user's credit history. One such consumer credit reporting agency comprises TRANSUNION. As further illustrated and described in relation to FIG. 8 is one set of a plurality of questions received from the consumer credit reporting agency and displayed at the rental platform.

The credit and background check module 116 may be configured to provide the plurality of questions to the user. In some implementations, by way of non-limiting example, the plurality of questions may include at least one of a county related to a user's physical address, a zip code related to a user's physical address, and a monetary amount related to a user's financial transaction. At least some of the data submitted in association with the identification module 108, income information module 110, and background information module 112 may be used to generate the questions. It is contemplated that having a user answer the plurality of questions may reduce fraudulent application submissions.

The credit and background check module 116 may be further configured to receive a response to the questions in the form of a plurality of answers from the user to the rental platform and send the plurality of answers from the rental platform to the consumer credit reporting agency. The information provided to the consumer credit reporting agency may be used to verify the identity of the user in order to subsequently obtain a user's credit history. One such user's credit history may comprise a soft credit check and/or a user's credit score. The credit and background check module 116 may utilize an application programming interface (“API”) to provide communications between the rental platform and the consumer credit reporting agency. Credit and background check module 116 may also be configured to receive at the rental platform a plurality of new questions from the consumer credit reporting agency when the plurality of answers provided to the initial questions are not accurate. Up to seven sets of questions, or more, may be provided to the user in response to inaccurate answers. User information module 128 may be configured to inform the user the application is complete.

Application denial receiving module 146 may be configured to receive an application denial request from the landlord to the rental platform and issue a denial letter from the rental platform to the user. The denial letter may be addressed from the rental platform.

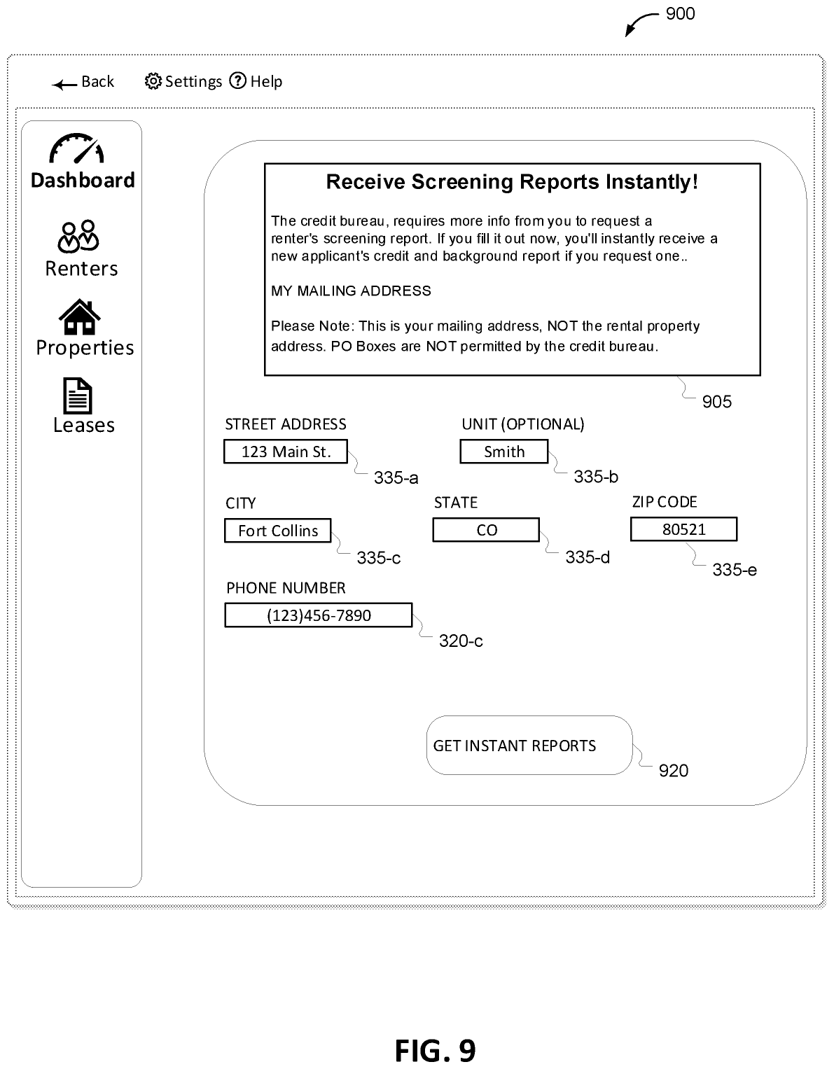

Landlord enabling module 130 may be configured to enable the landlord to access the information related to the user's credit history. For example, seen in FIG. 9 is one user interface that may enable a landlord to receive credit and background reports from a user. Such an interface may comprise having the landlord provide identifying information such as, but not limited to, providing a mailing address and a phone number. Upon the landlord entering the landlord identity information into the user interface, the information may be provided from the landlord to the rental platform and from the rental platform to the consumer credit reporting agency. In one embodiment, the landlord identity information may be provided when the landlord registers a rental property with the rental platform and prior to a user providing the user-identifying information from the user to the rental platform. After entering the landlord identifying information, when a user submits a rental application through the rental platform, approves the credit and background check request as described above and answers the identification verification questions, the landlord may receive the credit and background report instantly upon requesting to receive the report.

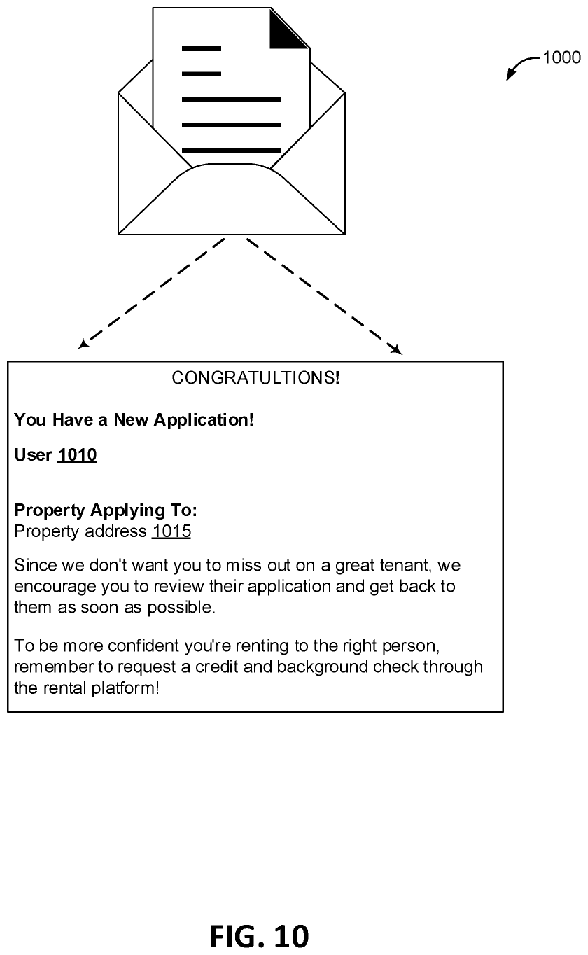

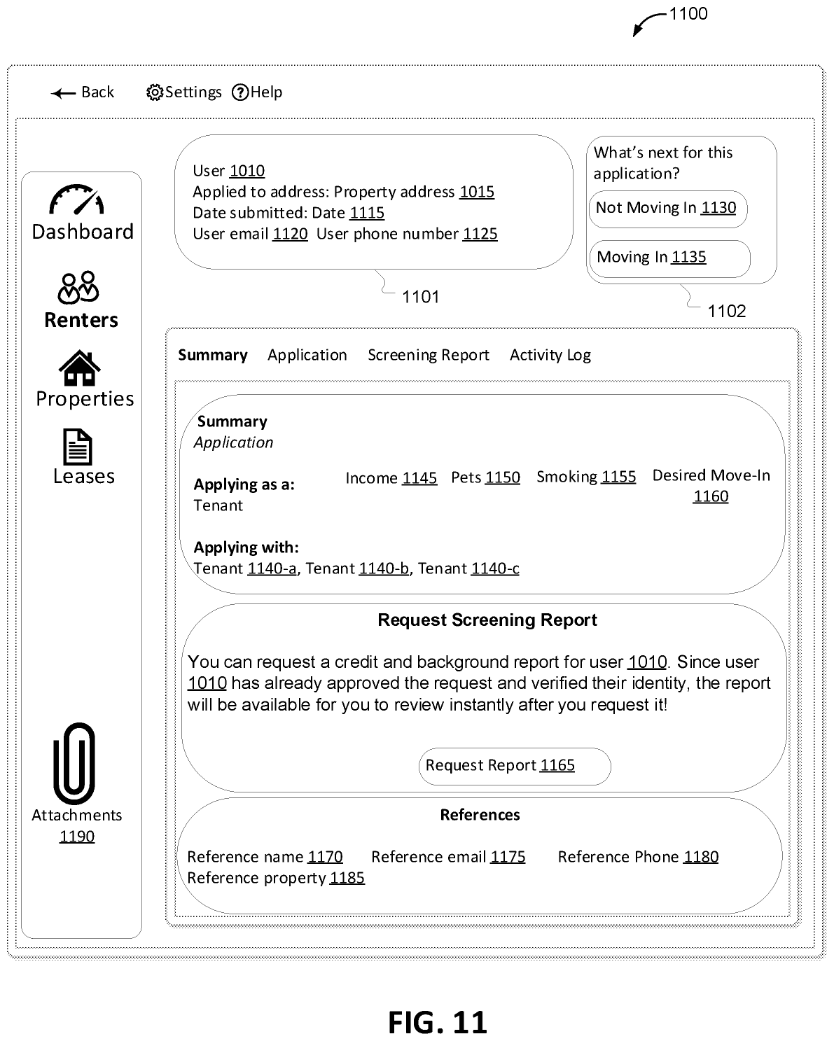

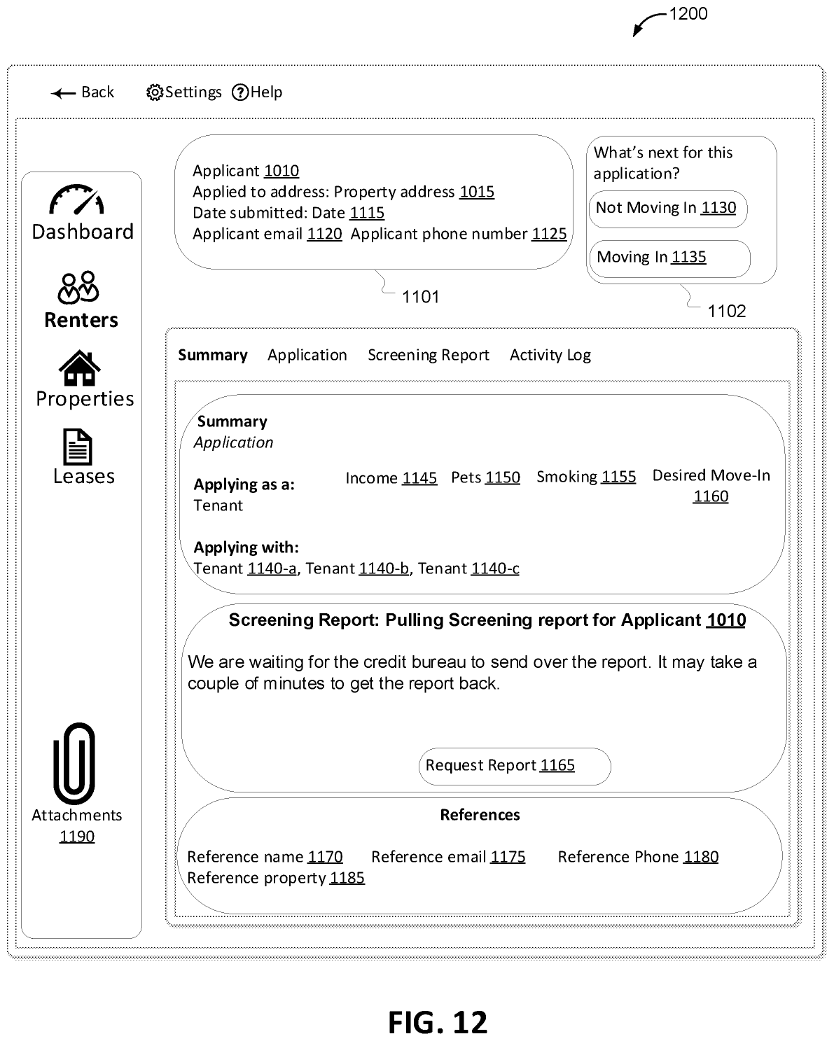

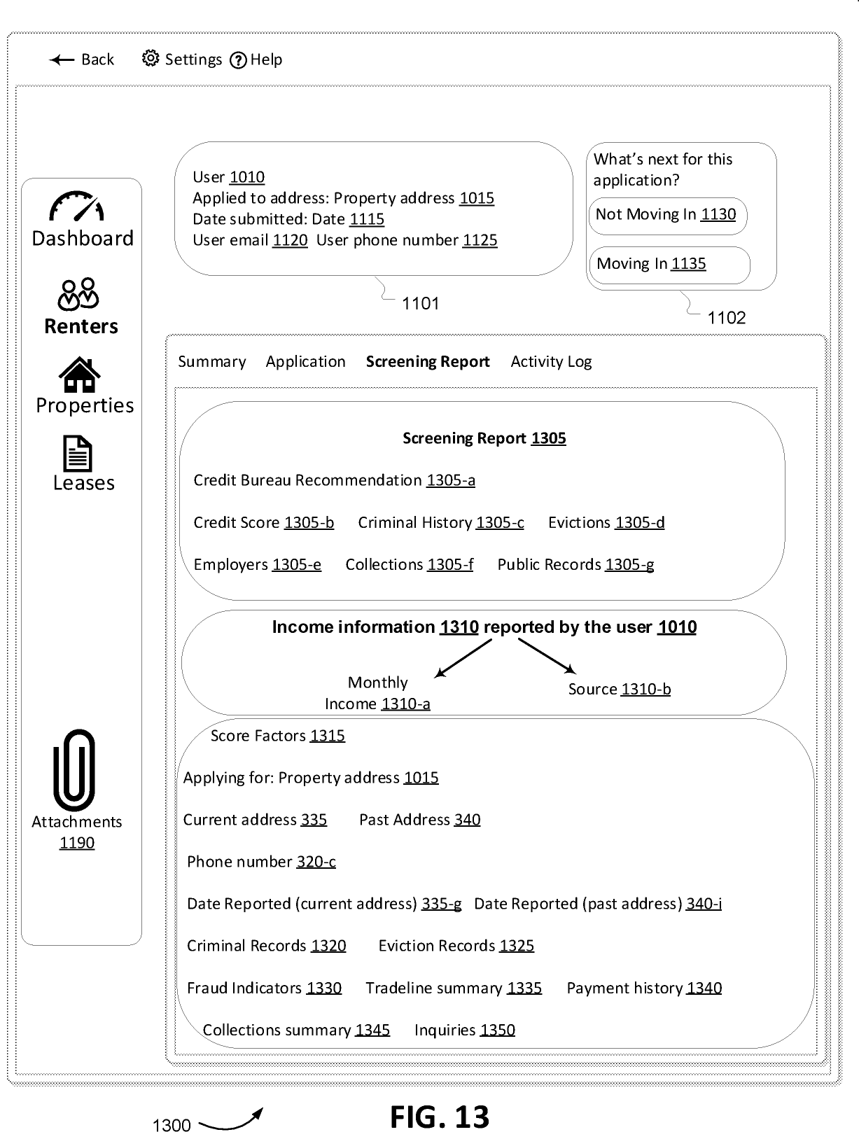

In one non-limiting example of this concept, and as seen in the user interface of FIG. 10, the landlord may be informed (e.g., via an email) from the rental platform that a user has submitted an application to lease a property. As seen in the user interface of FIG. 11, the application may enable the landlord to request the credit and background check for the user. FIG. 12 displays the same user interface as FIG. 11 after the landlord has requested the credit and background check. Further, FIG. 13 displays the same interface after the credit and background report is received. As seen, the report may include one or more of a credit score, score factors, late payment summary, and credit tradeline information. By way of non-limiting example, the credit and background report may further include one or more of an application acceptance/denial recommendation with a listing of any additional conditions needed to be met prior to acceptance of the application, any criminal history information, eviction history information, employment information, debt collection information, public record information, and fraud indicators. In some implementations, such a credit and background check may include obtaining an instant credit verification. Further, in one embodiment, it is contemplated that the landlord may include an owner of the real property (i.e., rental property).

Landlord enabling module 130 may be configured to have the landlord pre-approve a signed rental agreement if the credit and background report identifies that a user's credit history meets (e.g., is greater than or equal to) a predetermined level. The predetermined level may be set by the landlord or the system. Pre-approval of the signed rental agreement may be further dependent upon predictive analytic data based on recent history of the user such as, but not limited to, landlord references and other metrics obtained from social networking. One such credit history may comprise a credit score received form a consumer credit reporting agency. A predetermined level may comprise a credit score of 700. Other levels may comprise scores higher or lower than this level, such as, but not limited to, scores of 600, 650, 680, or 720. Other credit history may comprise income to rent ratio and/or other criteria set by a landlord. One rent ratio predetermined level may comprise 3. However, higher or lower levels such as, but not limited to 1.5 and/or 4.5, or anything in-between or outside this range may be set. With any such level, an applicant's monthly income may be divided by this ratio to determine if they meet the required rent ratio. For example, if a landlord has set the rent at $1000/month and the applicant has provided an income of $3,600/month, this applicant would meet the requirement of being at or higher the predetermined rent ratio of 3 ($3600/$1000). Other predictive analytic data and/or credit history may comprise type of debt, recency of det, credit limits, number of tradelines, other credit-based factors, criminal record, eviction information, and public records.

Agreement creation module 136 may be configured to automatically create and send a landlord-signed rental agreement to the user after receiving, at the rental platform, the credit and background report from the consumer credit reporting agency, and based at least in part on the user's credit history meeting the predetermined level. Agreement creation module 136 may be further configured to enable the user to digitally sign the rental agreement and send the digitally signed rental agreement from the user to the rental platform. In some examples, the digitally signed rental agreement may be accessible by the landlord via the rental platform.

Prior to a user submitting a rental application for a property, property adding module 150 may be utilized by a landlord to add a property to the rental platform. One such module is configured to enable providing information describing the property for rent, amenities of the property, photographs of the property, and terms of a rental agreement. Property adding module 150 may also be configured to list a property on a third-party listing platform. One such platform comprises ZILLOW. Other platforms are contemplated. Property adding module 150 may be configured to receive a response at the rental platform, from the user, via the third-party listing platform, and subsequently parse the data in the response. At least a portion of the parsed data may be displayed for the landlord on the rental platform.

Invitation sending module 160 may be configured to enable a landlord to send an invitation to the user from the rental platform to submit a rental application for the property. The rental application may comprise an application to lease real property. However, rental of personal property and ownership of personal or real property is also contemplated. The invitation may display contact information related to the third-party listing platform.

In some implementations, server(s) 102, client computing platform(s) 104, and/or external resources 162 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 162 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 162, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 162 may include sources of information outside of system 100, external entities participating with system 100, and/or other resources. In some implementations, some or all of the functionality attributed herein to external resources 162 may be provided by resources included in system 100.

Server(s) 102 may include electronic storage 164, one or more processors 166, also referred to herein as a hardware processor, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 164 may comprise non-transitory storage media that electronically stores information. The electronic storage media of electronic storage 164 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 164 may include one or more of optically readable storage media (e.g., optical disks, etc.), magnetically readable storage media (e.g., magnetic tape, magnetic hard drive, floppy drive, etc.), electrical charge-based storage media (e.g., Electrically Erasable Programmable Read-Only Memory (EEPROM), Random Access Memory (RAM), etc.), solid-state storage media (e.g., flash drive, etc.), and/or other electronically readable storage media. Electronic storage 164 may include one or more virtual storage resources (e.g., cloud storage, a virtual private network, and/or other virtual storage resources). Electronic storage 164 may store software algorithms, information determined by processor(s) 166, information received from server(s) 102, information received from client computing platform(s) 104, and/or other information that enables server(s) 102 to function as described herein.

Processor(s) 166 may be configured to provide information processing capabilities in server(s) 102. As such, processor(s) 166 may include one or more of a digital processor, an analog processor, a digital circuit designed to process information, an analog circuit designed to process information, a state machine, and/or other mechanisms for electronically processing information. Although processor(s) 166 is shown in FIG. 1 as a single entity, this is for illustrative purposes only. In some implementations, processor(s) 166 may include a plurality of processing units. These processing units may be physically located within the same device, or processor(s) 166 may represent processing functionality of a plurality of devices operating in coordination. Processor(s) 166 may be configured to execute modules 108, 110, 112, 114, 116, 128, 130, 136, 146, 150, and/or 160, and/or other modules. Processor(s) 166 may be configured to execute modules 108, 110, 112, 114, 116, 128, 130, 136, 146, 150, and/or 160 and/or other modules by software; hardware; firmware; some combination of software, hardware, and/or firmware; and/or other mechanisms for configuring processing capabilities on processor(s) 166. As used herein, the term “module” may refer to any component or set of components that perform the functionality attributed to the module. This may include one or more physical processors during execution of processor readable instructions, the processor readable instructions, circuitry, hardware, storage media, or any other components. Furthermore, one or more of the modules described herein may comprise more than one module or may be combined with one or more additional module into a single module.

It should be appreciated that although 108, 110, 112, 114, 116, 128, 130, 136, 146, 150, and/or 160 are illustrated in FIGS. 1A and 1B as being implemented within a single processing unit, in implementations in which processor(s) 166 includes multiple processing units, one or more of modules 108, 110, 112, 114, 116, 128, 130, 136, 146, 150, and/or 160 may be implemented remotely from the other modules. The description of the functionality provided by the different modules 108, 110, 112, 114, 116, 128, 130, 136, 146, 150, and/or 160 described below is for illustrative purposes, and is not intended to be limiting, as any of modules 108, 110, 112, 114, 116, 128, 130, 136, 146, 150, and/or 160 may provide more or less functionality than is described. For example, one or more of modules 108, 110, 112, 114, 116, 128, 130, 136, 146, 150, and/or 160 may be eliminated, and some or all of its functionality may be provided by other ones of modules 108, 110, 112, 114, 116, 128, 130, 136, 146, 150, and/or 160. As another example, processor(s) 166 may be configured to execute one or more additional modules that may perform some or all of the functionality attributed below to one of modules 108, 110, 112, 114, 116, 128, 130, 136, 146, 150, and/or 160.

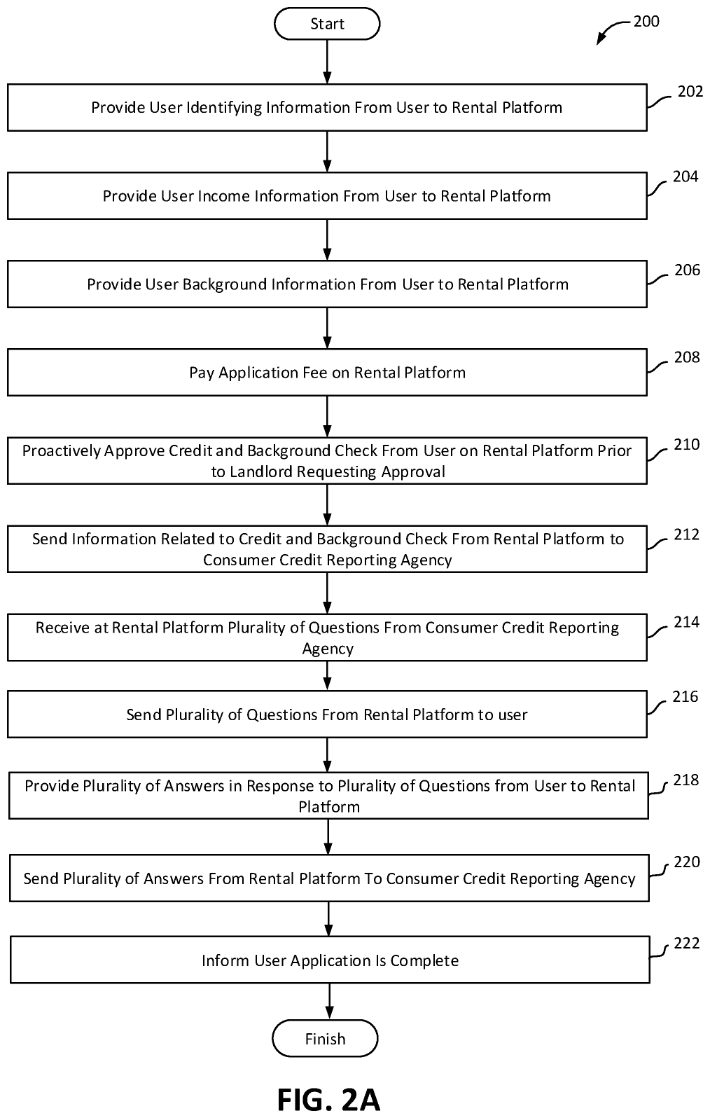

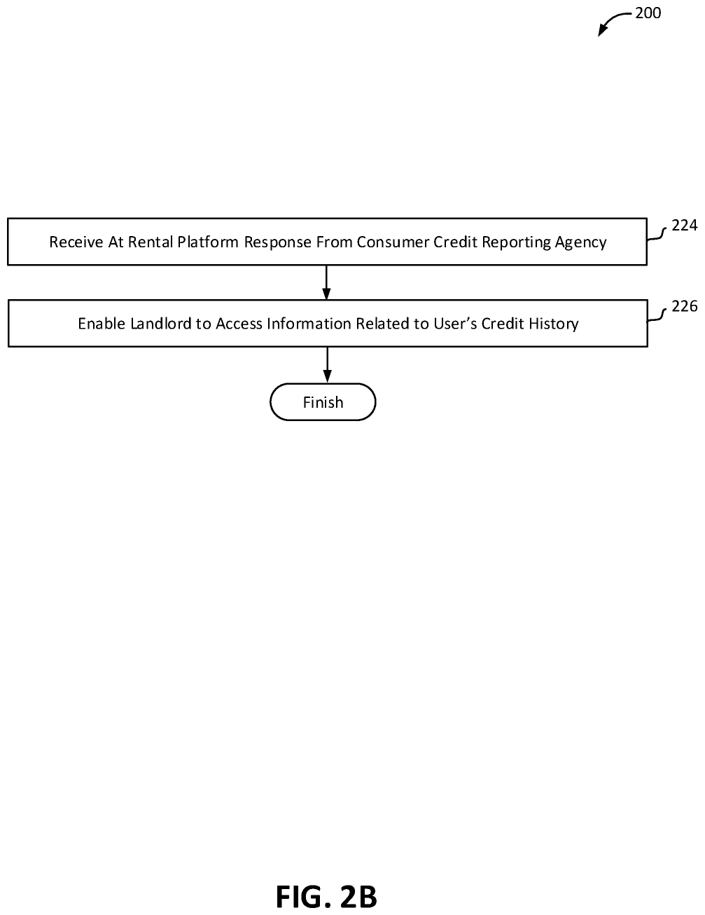

FIGS. 2A and 2B illustrates a method 200 for submitting a rental application, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A and 2B and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include providing user identifying information from a user to a rental platform. Operation 202 may be performed by one or more hardware processors configured by machine-readable instructions including a module that is the same as or similar to user identification module 108, in accordance with one or more implementations.

An operation 204 may include providing user income information from a user to the rental platform. Operation 204 may be performed by one or more hardware processors configured by machine-readable instructions including a module that is the same as or similar to user income information module 110, in accordance with one or more implementations.

An operation 206 may include providing user background information from a user to the rental platform. Operation 206 may be performed by one or more hardware processors configured by machine-readable instructions including a module that is the same as or similar to user background information module 112, in accordance with one or more implementations.

An operation 208 may include paying an application fee on the rental platform. Operation 208 may be performed by one or more hardware processors configured by machine-readable instructions including a module that is the same as or similar to application fee payment module 114, in accordance with one or more implementations.

An operation 210 may include proactively approving a credit and background check from the user on the rental platform prior to a landlord requesting the approval. Operation 210 may be performed by one or more hardware processors configured by machine-readable instructions including a module that is the same as or similar to credit background check approving module 116, in accordance with one or more implementations.

An operation 212 may include sending information related to the credit and background check from the rental platform to a consumer credit reporting agency. Operation 212 may be performed by one or more hardware processors configured by machine-readable instructions including a module that is the same as or similar to credit background check approving module 116, in accordance with one or more implementations.

An operation 214 may include receiving at the rental platform a plurality of questions from the consumer credit reporting agency. Operation 214 may be performed by one or more hardware processors configured by machine-readable instructions including a module that is the same as or similar to credit background check approving module 116, in accordance with one or more implementations.

An operation 216 may include sending the plurality of questions from the rental platform to the user. Operation 216 may be performed by one or more hardware processors configured by machine-readable instructions including a module that is the same as or similar to credit background check approving module 116, in accordance with one or more implementations.

An operation 218 may include providing a plurality of answers in response to the plurality of questions from the user to the rental platform. Operation 218 may be performed by one or more hardware processors configured by machine-readable instructions including a module that is the same as or similar to credit background check approving module 116, in accordance with one or more implementations.

An operation 220 may include sending the plurality of answers from the rental platform to the consumer credit reporting agency. Operation 220 may be performed by one or more hardware processors configured by machine-readable instructions including a module that is the same as or similar to credit background check approving module 116, in accordance with one or more implementations.

An operation 222 may include informing the user the application is complete. Operation 222 may be performed by one or more hardware processors configured by machine-readable instructions including a module that is the same as or similar to user information module 128, in accordance with one or more implementations.

An operation 224 may include receiving at the rental platform a response from the consumer credit reporting agency. The response may include information related to the user's credit history. Operation 224 may be performed by one or more hardware processors configured by machine-readable instructions including a module that is the same as or similar to credit background check approving module 116, in accordance with one or more implementations.

An operation 226 may include enabling the landlord to access the information related to the user's credit history. Operation 226 may be performed by one or more hardware processors configured by machine-readable instructions including a module that is the same as or similar to landlord enabling module 130 and/or to credit background check approving module 116, in accordance with one or more implementations.

FIGS. 3A and 3B illustrate visualizations of user interfaces 301 and 302, respectively, for a user providing user information according to various embodiments of the disclosure. In some examples, aspects of the present disclosure may comprise a mobile app or website displaying the user interface 301 or 302 of a rental platform system. In some cases, the rental platform system may be an example of system 100 described in relation to FIG. 1. Further, the user may access the mobile app or website using a network connected device, such as a smart phone, tablet, laptop, NetBook, etc.

As illustrated, user interface 301 may allow the user to submit a rental application for property address 305, based at least in part on providing user information. In some embodiments, a landlord may add a real property (i.e., a physical property) at the property address 305 to the rental platform system by providing one of more of: information describing the property for rent, amenities of the property (e.g., air conditioning, covered garage, swimming pool and/or gym, etc.), photographs of the property, and terms of a rental agreement (e.g., rent, security deposit, pets allowed/not allowed, smoking allowed/not allowed, etc.). In some other embodiments, the landlord may add the rental listing for the property address 305 on a third-party platform separate from the rental platform system of the current disclosure. Some examples of such third-party platforms for posting rental listings may include CRAIGSLIST, ZILLOW, ROOMSTER, etc. In yet other embodiments, the user may receive an invitation to submit a rental application for the property. The invitation may be sent from the rental platform, the landlord, or through other means, such as a person who is familiar with the rental platform system of the present disclosure.

After finding the rental property listed by the landlord at property address 305, user may proceed to fill out and submit a rental application using the user interface 301. For instance, user interface 301 may include an About You 315 section, where the user may enter their first name, last name, and date of birth in text boxes 315-a, 315-b, and 315-c respectively. Further, the user interface 301 may include a section (i.e., Your Contact Information 320) for allowing the user to input their contact information. In some examples, the user may enter their email address in text box 320-a, confirm their email address in text box 320-b, enter a primary phone number in text box 320-c, and select a type of phone 320-d associated with the primary phone number. In some cases, the user may also have the option of entering a second phone number in text box 320-e, as well as indicate a type of phone 320-f associated with the second phone number. In some cases, the type of phone may comprise a mobile phone, home phone, or work phone, to name a few non-limiting examples, and a user may select the type of phone using the radio buttons shown. It should be noted that the radio buttons are merely used an example, and the user interface 301 may display check boxes or request the user to enter the type of phone in a text box, in other embodiments.

In some examples, the user interface 301 may also include an Emergency Contact 325 section, where a user may enter a full name, phone number, and relationship (i.e., parent, friend, spouse, partner, etc.) of a first emergency contact in text boxes 325-a, 325-b, and 325-c respectively. In some cases, the user interface 301 may also allow a user to enter a full name, phone number, and relationship of a second or alternate emergency contact in text boxes 325-d, 325-e, and 325-f, respectively.

As illustrated, the user interface 301 of the rental platform system may allow a user to save and finish the rental application at a later time via a Save & Finish Later button 310. In some instances, the user interface 301 may also display one or more prompts 330 (e.g., prompt 330-a) while the user is filling out their rental application.

FIG. 3B illustrates a visualization of the user interface 302 for a user providing user information according to various embodiments of the disclosure. In some examples, user interface 302 may implement aspects of user interface 301, as described with reference to FIG. 3A. As illustrated in user interface 302, the user (i.e., potential tenant) may be prompted to provide information about their current address 335, which may include one or more of a street address, a unit (optional), a city, a state, and a zip code. In some examples, the user may type one or more of their street address, unit, city, state, and zip code in text boxes 335-a, 335-b, 335-c, 335-d, and 335-e, respectively. In some other cases, the user may select their city, state, and/or zip code from a drop-down menu. The user may also be prompted to select a residence type 335-f for current address 335, for instance, using the radio buttons shown. In other embodiments, the user may select the residence type 335-f using a drop-down menu or input it in a text box. In some cases, the user may also enter a date that they moved into their current address in text box 335-g.

In some examples, the user may enter a response to the question “Why Are You Moving? (optional)” in text box 335-h displayed on the user interface. Further, the user interface 302 may also request the user to input contact information for their current landlord (i.e., Landlord Contact Info), including a full name (text box 335-i), phone number (text box 335-j), and an email (text box 335-k).

Besides information about current address 335, the user interface 302 may also require the user to provide information on one or more past addresses 340. For instance, the user may input a street address (text box 340-a), unit (text box 340-b), city (text box 340-d), state (text box 340-e), and/or a zip code (text box 340-f). Similar to the current address 335 section, the user interface 302 may request the user to explain their living situation in the past address (i.e., in text box 340-c), as well as why they moved (i.e., in text box 340-g). In some examples, the user may also select their residence type 340-h at their past address via the radio buttons shown, and/or enter a date moved in (i.e., in text box 340-i). In some instances, the user interface 302 may also display one or more prompts 330 (e.g., prompt 330-b) to assist the user in filling out and submitting their rental application.

FIG. 4 illustrates a visualization of a user interface 400 for a user providing income information according to various embodiments of the disclosure. In some examples, user interface 400 may implement aspects of user interfaces 301 or 302, as described with reference to FIGS. 3A and 3B. As illustrated in user interface 400, the user may provide information on a current employer 415, including one or more of an employer name in text box 415-a, city in text box 415-b, position/occupation in text box 415-c, a monthly income in text box 415-d, a contact name in text box 415-e, a contact phone number in text box 415-f, and a start date in text box 415-g. If the user is not employed, the user may select the “Not currently employed” radio button. As described above, the radio button may be replaced with a check box, in some embodiments.

In some examples, the user may provide information on any additional employers 420, including one or more of an additional employer in text box 420-a, a city in text box 420-b, position/occupation in text box 420-c, a monthly income in text box 420-d, a contact name in text box 420-e, a contact phone number in text box 420-f, and a start date in text box 420-g.

Additionally or alternatively, the user interface 400 may also request the user for information on other income sources 425, including one or more of a monthly income (i.e., in text box 425-a) and a source (i.e., in text box 425-b). In some embodiments, the user may also provide information on a bank or financial institution they utilize, which may be input under Bank/Financial Institution Name (i.e., in text box 430).

As shown, the user interface 400 may also display one or more prompts 330 (e.g., prompt 330-c) to assist the user in filling out and submitting their rental application.

FIG. 5A illustrates a visualization of a user interface 501 for a user providing user information according to various embodiments of the disclosure. In some examples, user interface 501 may implement aspects of user interfaces 301, 302, or 400, as described with reference to FIGS. 3A, 3B, and 4. As illustrated, user interface 501 may comprise a general information 515 section, where the user may be requested to input information, via radio buttons 515-a, on any pets that may live at property address 305. If so, the user interface 501 may also prompt the user to input additional information on the pet, including a type (dog, cat, etc.) in text box 515-b, a breed (if applicable) in text box 515-c, weight of pet in text box 515-d, age of pet in text box 515-e, and sex of pet (Male/Female) in text box 515-f. In some embodiments, the user may be given the option to add additional pets via user interface 500.

As shown, the user interface 501 may also prompt the user to input information on any vehicles that would be located at the property. For instance, the user may indicate if they plan on having any vehicles (i.e., Yes or No) via radio buttons 515-h. Further, the user may input additional information on the vehicle, including a Make and Model of the vehicle in text boxes 515-i and 515-j, respectively, a vehicle color in text box 515-k, a year for the vehicle in text box 515-l, and/or a license plate of the vehicle in text box 515-m.

In some cases, the user may also indicate if they smoke (e.g., Yes/Occasionally/Outdoors only/No) via radio buttons 515-n presented on the user interface 501.

FIG. 5B illustrates a visualization of a user interface 502 for a user providing user information according to various embodiments of the disclosure. In some examples, user interface 502 may implement aspects of user interfaces 301, 302, 400, or 501 as described with reference to FIGS. 3A, 3B, 4, and 5A. As shown, the user may be asked to provide background information 520 in response to one or more questions displayed on the user interface 502. In one example, the user may be asked “Have you (or any person you have named on this application) ever been evicted from a tenancy or left owing money?”, to which the user may indicate “Yes” or “No” via radio buttons 520-a. Additionally or alternatively, the user may be asked to indicate “Yes” or “No” to the question “Criminal Charges (Pending or Convicted), other than minor traffic infractions, for you or any persons named on this application?” via radio buttons 520-c.

In yet other cases, the user may indicate a “Yes” or “No” to the question “Have you or any persons named on this application ever filed for bankruptcy/been foreclosed/been a defendant in a civil suit?” via radio buttons 520-e. As shown in the Please Explain section, the user may provide a more detailed explanation to one or more of the questions above via text boxes 520-b, 520-d, and 520-f.

As shown in Other Information 525 section, the user may be asked “Do you have any special needs or requirements we should be aware of?”, to which the user may indicate a “Yes” or “No” via radio buttons 525-a. If Yes, the user may be requested to provide more details in text box 525-b in the Please Explain section. In one example, the user may also input any relevant questions or comments regarding property address 305 for the landlord in text box 525-c.

In some examples, the user interface may prompt the user to provide an explanation to one or more of the questions, for instance, if the user indicates a “Yes” for a question. In other cases, the Please Explain section may be optional (i.e., regardless of the option selected by the user), for instance, based on minimum requirements set by the landlord. In some embodiments, the rental platform may allow the landlord or rental property manager to configure the questions or sections that are required and optional. Further, the rental platform system may allow landlords to vary the questions (or wording of questions) presented, amount of information needed from users or potential tenants (e.g., 3 years or 5 years past rental history, 1 contact reference or 2 contact references, etc.), options displayed to users (e.g., Smoking: 4 options as shown in FIG. 5A, or 2 options—Outdoors only and No), etc., on the user interface.

FIG. 5C illustrates a visualization of a user interface 503 for a user submitting a rental application according to various embodiments of the disclosure. In some examples, user interface 502 may implement aspects of user interfaces 301, 302, 400, 501, or 502 as described with reference to FIGS. 3A, 3B, 4, 5A, or 5B. In one example, the user may be requested to provide an answer to the question “How did you find this property (Optional)?” in text box 525-d. Additionally or alternatively, the user may be requested to input any other comments or explanations regarding their rental application in text box 525-e.

As shown, under Authorization 530 section, the user interface 503 may display a dialog box 530-a comprising a rental application agreement. In order to proceed with submitting the rental application, the user may be required to select check box 530-b. Following authorization, the user may continue to “Next: Documents” 535 section of the rental application for uploading documents (e.g., scans of driving license/State ID/passport, paystubs, utility bills for proof of address, etc.) requested by the landlord or property manager.

FIG. 6A illustrates a visualization of a user interface 601 for a user paying an application fee according to various embodiments of the disclosure. In some examples, the application fee may be displayed in box 630 of the user interface. Box 630 may be an example of a push button, and may be configured to be selectable by the user. In some examples, user interface 601 may implement aspects of user interfaces 301, 302, 400, 501, 502, or 503 as described with reference to FIGS. 3A, 3B, 4, 5A, 5B, or 5C. In some circumstances, the application fee may be set by the landlord or property manager. Alternatively, the application fee may be set by the rental platform. As shown, after agreeing to the terms and conditions and rental application agreement in FIG. 5C, the rental platform system on the user's network connected device may request the user to set up payment, including one or more of an email address in text box 605, a credit card or debit card number in text box 610, an expiration date (e.g., format MM/YY) of the card in text box 615, a security code of the card in text box 620, and a coupon code (optional) in text box 625.

FIG. 6B illustrates a visualization of a user interface 602 for a user pre-approving requests for credit and background checks according to various embodiments of the disclosure. In some examples, user interface 602 may implement aspects of user interfaces 301, 302, 400, 501, 502, 503, or 601 as described with reference to FIGS. 3A, 3B, 4, 5A, 5B, 5C, or 6A. In some circumstances, users of the rental platform system may pre-approve requests for credit and background checks prior to any requests from the landlord for the same. As shown, the user interface 602 may display a dialog box 605 explaining the credit and background check pre-approval process. In some circumstances, pre-approving may optimize the rental application process by decreasing the amount of back and forth communications between the landlord and the user, since the credit and background check report(s) may be available for the landlord upon request. As shown, the user may proactively pre-approve the request by clicking button 610. In other cases, the user may have the option of rejecting the request or approving it at a later time by clicking button 615.

FIG. 7 illustrates a visualization of user interface 700 for obtaining credit and background check information from a user according to various embodiments of the disclosure. In some examples, user interface 700 may implement aspects of user interfaces 301-302, 400, 501-503, or 601-602 as described with reference to FIGS. 3A-3B, 4, 5A-C, or 6A-B. As seen in FIG. 7, after proactively approving the credit and background check on the rental platform in FIG. 6B, the user may provide a social security number and confirmation of the same in text boxes 705-a and 705-b, respectively. Further, the user may provide income and employment status information to the rental platform in text boxes 710 and 715, respectively. In some examples, the user may also indicate an income frequency (e.g., monthly or bi-weekly) via radio buttons 720. After filling out the requested information on user interface 700, the user may select button 725 and proceed to answer one or more identity questions, further described in relation to FIG. 8.

FIG. 8 illustrates a visualization of user interface 800 displaying examples of questions received from a consumer credit reporting agency (e.g., TRANSUNION) according to various embodiments of the disclosure. In some examples, user interface 800 may implement aspects of user interfaces 301-302, 400, 501-503, 601-602, or 700 as described with reference to FIGS. 3A-3B, 4, 5A-C, 6A-B, or 7. In some cases, consumer credit reporting agencies may also be referred to as credit bureaus, and for the purposes of this disclosure, they may be used interchangeably.

As shown, in order to prevent identity theft and to ensure accuracy in screening, the user may be asked to confirm a county that they live in from county options 801 (e.g., county option 801-a through e) displayed on the rental platform's user interface 800. Similarly, the user may also select from one of zip options 802 (e.g., zip option 802-a through e) and mortgage options 803 (e.g., mortgage option 803-a through e) to verify their identity for credit and background check purposes. In some examples, the user interface 800 may display “None of the above” or “Not listed” as an option for one or more of the county (e.g., county option 801-e), zip code (e.g., ZIP option 802-e), and mortgage (e.g., mortgage option 803-e) options. After selecting the answers for the one or more questions displayed on user interface 800, the user may select Finish button 805 to submit their rental application on the rental platform. In some examples, upon submitting the rental application, the plurality of answers may be sent from the rental platform to the consumer credit report agency. Further, the user may receive an electronic confirmation via email (e.g., to the email address listed under Your Contact Information 320 in FIG. 3) or phone (e.g., a SMS or text to the phone number listed under Your Contact Information 320 in FIG. 3) that their rental application has been successfully submitted on the rental platform. It should be noted that the user may be allowed to edit or update responses to one or more previously answered questions before submission.

FIG. 9 illustrates a visualization of a user interface 900 for a user requesting a screening report according to various embodiments of the disclosure. In some examples, user interface 900 may implement aspects of user interfaces 301-302, 400, 501-503, 601-602, 700, or 800 as described with reference to FIGS. 3A-3B, 4, 5A-C, 6A-B, 7, or 8.

In some embodiments, the user may request a copy of the renter's screening report that will be provided to the landlord from the consumer credit reporting agency or credit bureau. In some cases, the screening report may comprise one or more of a credit and background check. The credit check may comprise one or more of a credit score, tradeline summary, payment history, collections summary, public records, credit inquiries, and a credit bureau recommendation for the user, further described in relation to FIG. 13. In some cases, the background check may comprise one or more of criminal records, fraud indicators, eviction records, and other public records for the user, also described in FIG. 13.

In order to receive a screening report, the user may provide address information (e.g., Current Address 335 in FIG. 3B) or phone number information (e.g., Phone Number listed in text box 320-c of FIG. 3A) to the credit reporting agency via the rental platform's user interface 900. In some examples, the rental platform system may auto-populate the text boxes displayed on user interface 900 based on the previously provided address or phone number information. As shown, after filling in the required text boxes, the user may receive their screening report by selecting button 920.

FIG. 10 illustrates an example of an electronic message, such as an email 1000, notifying the landlord of a new application for property address 1015, which may be the same as property address 305 in FIGS. 3 through 8. In other embodiments, the rental platform system may comprise a mobile app installed on a network connected device utilized by the landlord, such as a tablet, a smart phone, a NetBook, etc., and the electronic message may comprise a push notification on the mobile app. In yet other embodiments, the landlord may receive a text or SMS message, or even a phone call notifying them of the rental application recently submitted by the user. In some cases, the landlord may select one or more filters for the notifications (e.g., new application, credit and background check results available, application withdrawn, etc.) and how (e.g., push notification in mobile app, emails, SMS, etc.) they want to receive them via the rental platform system.

As shown, contents of email 1000 may include at least user information on applicant 1010 and the property address 1015. In some cases, the user information may comprise some or all of the information provided by the user in the About You 315 section and/or the Your Contact Information 320 section in FIG. 3A.

FIG. 11 illustrates a visualization of a user interface 1100 for a landlord accessing the user's rental application according to various embodiments of the disclosure. As shown, in upper left pane 1101, the user interface 1100 may display user information for user 1010, property address 1015, date 1115 when the rental application was submitted by the user, user email address 1120, and user phone number 1125. Further, the user interface 1100 may display a summary of the rental application, including information provided by the user in one or more of FIGS. 3A-C, 4, 5A-C, and 7-9. For instance, the user interface 1100 may display income 1145, pets 1150, smoking 1155, desired move in 1160, etc. The user interface 1100 may also list one or more tenants 1140 (e.g., tenant 1140-a, tenant 1104-b, tenant 1140-c) named on the user's application.

In some circumstances, the landlord may request a screening report (i.e., Request Report 1165) for the user 1010. In such cases, and as discussed in FIGS. 6B through 9, if the user 1010 has proactively pre-approved the request for the credit and background check, the screening report may be displayed on the user interface. In other cases, if the user 1010 has not pre-approved the request for the credit and background check, the rental platform system may contact the user 1010 for authorization prior to requesting the screening report from the credit bureau.

In some embodiments, the summary of the rental application may also include reference information provided by the user, including one or more of a reference name 1170, reference email 1175, reference phone number 1180, and reference property address 1185. In some examples, the landlord may view one or more attachments 1190 uploaded by the user, such as scans of identity documents, pay stubs for income information, proof of address, etc.

FIG. 12 illustrates a visualization of a user interface 1200 for a landlord accessing the user's rental application according to various embodiments of the disclosure. User interface 1200 may implement one or more aspects of user interface 1100 as described with reference to FIG. 11. After receiving the request for the user's screening report, the rental platform system may forward the same to the credit bureau or consumer credit reporting agency. In some examples, the credit bureau may locate and pull the screening report for the user 1010 and relay it to the rental platform for display on the user interface, as further described in relation to FIG. 13.

FIG. 13 illustrates a visualization of a user interface 1300 for a landlord accessing the user's rental application according to various embodiments of the disclosure. User interface 1300 may implement one or more aspects of the user interfaces described in relation to FIGS. 11 and 12. As shown, the rental platform's user interface 1300 displays screening report 1305 after receiving it from the credit bureau. The screening report 1305 may comprise one or more of a credit bureau recommendation 1305-a for the user, a credit score 1305-b for the user, and past or current employers 1305-e of the user. In some embodiments, the screening report 1305 may also comprise a brief overview (e.g., “Yes” or “No” indication) of any criminal history 1305-c, evictions 1305-d, collections 1305-f, or public records 1305-g for the user.

As shown, user interface 1300 may also display income information 1310 reported by the user 1010, which may include at least a monthly income 1310-a and an income source 1310-b. As previously described, the income source 1310-b may be one or more of social security, alimony, parental assistance, scholarships, etc. Further, the income information 1310 may be similar to or substantially similar to the income information reported in FIG. 4 or FIG. 7.

In some embodiments, the user interface 1300 may also display one or more of score factors 1315, past and current address information 335 and 340, respectively, for the user, including reporting dates 335-g and 340-i for the addresses, and phone number 320-c of the user.

While the screening report 1305 includes a brief overview of the user's background, the user interface 1300 may also display detailed records for the user 1010, if requested by the landlord. For instance, the detailed records may include one or more of criminal records 1320, eviction records 1325, fraud indicators 1330, tradeline summary 1335, payment history 1340 for one or more accounts in the tradeline summary, collections summary 1345, and credit inquiries 1350 for the user. In some cases, the tradeline summary 1335 may comprise a list of one or more credit accounts or credit cards that are open and active by the user, including the Bank/Financial Institution that has issued the account, total credit line for each account, balance on each account, remaining credit line, etc. In some other cases, the tradeline summary 1335 may also list inactive or defunct credit accounts. In some cases, credit inquiries 1350 may include a listing of all “hard” inquiries, and optionally “soft” inquiries pertaining to the user 1010. It should be noted that “hard” inquiries may affect the user's credit score, whereas “soft” inquiries leave the credit score largely unchanged.

In some examples, user interface 1300 may display screening reports and detailed records for all tenants listed on the user's rental application, not just the user 1010, which may assist the landlord in making more informed decisions on the rental application.

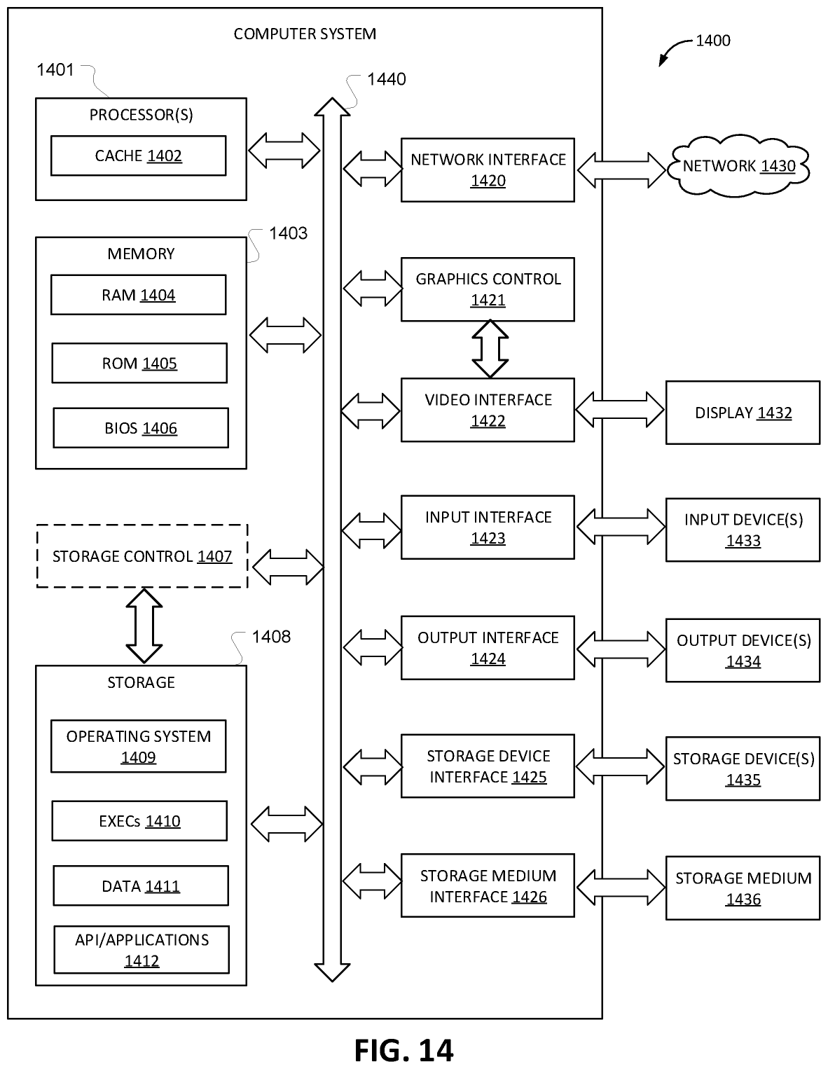

FIG. 14 illustrates a diagrammatic representation of one embodiment of a computer system 1400, within which a set of instructions can execute for causing a device to perform or execute any one or more of the aspects and/or methodologies of the present disclosure. The components in FIG. 14 are examples only and do not limit the scope of use or functionality of any hardware, software, firmware, embedded logic component, or a combination of two or more such components implementing particular embodiments of this disclosure. Some or all of the illustrated components can be part of the computer system 1400. For instance, the computer system 1400 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 1400 includes at least a processor 1401 such as a central processing unit (CPU) or a graphics processing unit (GPU) to name two non-limiting examples. Any of the subsystems described throughout this disclosure could embody the processor 1401. The computer system 1400 may also comprise a memory 1403 and a storage 1408, both communicating with each other, and with other components, via a bus 1440. The bus 1440 may also link a display 1432, one or more input devices 1433 (which may, for example, include a keypad, a keyboard, a mouse, a stylus, etc.), one or more output devices 1434, one or more storage devices 1435, and various non-transitory, tangible computer-readable storage media 1436 with each other and/or with one or more of the processor 1401, the memory 1403, and the storage 1408. All of these elements may interface directly or via one or more interfaces or adaptors to the bus 1440. For instance, the various non-transitory, tangible computer-readable storage media 1436 can interface with the bus 1440 via storage medium interface 1426. Computer system 1400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1401 (or central processing unit(s) (CPU(s))) optionally contains a cache memory unit 1432 for temporary local storage of instructions, data, or computer addresses. Processor(s) 1401 are configured to assist in execution of computer-readable instructions stored on at least one non-transitory, tangible computer-readable storage medium. Computer system 1400 may provide functionality as a result of the processor(s) 1401 executing software embodied in one or more non-transitory, tangible computer-readable storage media, such as memory 1403, storage 1408, storage devices 1435, and/or storage medium 1436 (e.g., read only memory (ROM)). Memory 1403 may read the software from one or more other non-transitory, tangible computer-readable storage media (such as mass storage device(s) 1435, 1436) or from one or more other sources through a suitable interface, such as network interface 1420. Any of the subsystems herein disclosed could include a network interface such as the network interface 1420. The software may cause processor(s) 1401 to carry out one or more processes or one or more steps of one or more processes described or illustrated herein. Carrying out such processes or steps may include defining data structures stored in memory 1403 and modifying the data structures as directed by the software. In some embodiments, an FPGA can store instructions for carrying out functionality as described in this disclosure. In other embodiments, firmware includes instructions for carrying out functionality as described in this disclosure.

The memory 1403 may include various components (e.g., non-transitory, tangible computer-readable storage media) including, but not limited to, a random-access memory component (e.g., RAM 1404) (e.g., a static RAM “SRAM”, a dynamic RAM “DRAM”, etc.), a read-only component (e.g., ROM 1405), and any combinations thereof. ROM 1405 may act to communicate data and instructions unidirectionally to processor(s) 1401, and RAM 1404 may act to communicate data and instructions bidirectionally with processor(s) 1401. ROM 1405 and RAM 1404 may include any suitable non-transitory, tangible computer-readable storage media. In some instances, ROM 1405 and RAM 1404 include non-transitory, tangible computer-readable storage media for carrying out a method. In one example, a basic input/output system 1406 (BIOS), including basic routines that help to transfer information between elements within computer system 1400, such as during start-up, may be stored in the memory 1403.

Fixed storage 1408 is connected bi-directionally to processor(s) 1401, optionally through storage control unit 1407. Fixed storage 1408 provides additional data storage capacity and may also include any suitable non-transitory, tangible computer-readable media described herein. Storage 1408 may be used to store operating system 1409, EXECs 1410 (executables), data 1411, API applications 1412 (application programs), and the like. Often, although not always, storage 1408 is a secondary storage medium (such as a hard disk) that is slower than primary storage (e.g., memory 1403). Storage 1408 can also include an optical disk drive, a solid-state memory device (e.g., flash-based systems), or a combination of any of the above. Information in storage 1408 may, in appropriate cases, be incorporated as virtual memory in memory 1403.

In one example, storage device(s) 1435 may be removably interfaced with computer system 1400 (e.g., via an external port connector (not shown)) via a storage device interface 1425. Particularly, storage device(s) 1435 and an associated machine-readable medium may provide nonvolatile and/or volatile storage of machine-readable instructions, data structures, program modules, and/or other data for the computer system 1400. In one example, software may reside, completely or partially, within a machine-readable medium on storage device(s) 1435. In another example, software may reside, completely or partially, within processor(s) 1401.

Bus 1440 connects a wide variety of subsystems. Herein, reference to a bus may encompass one or more digital signal lines serving a common function, where appropriate. Bus 1440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1400 may also include an input device 1433. In one example, a user of computer system 1400 may enter commands and/or other information into computer system 1400 via input device(s) 1433. Examples of an input device(s) 1433 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 1433 may be interfaced to bus 1440 via any of a variety of input interfaces 1423 (e.g., input interface 1423) including, but not limited to, serial, parallel, game port, USB, FIREWIRE, THUNDERBOLT, or any combination of the above.

In particular embodiments, when computer system 1400 is connected to network 1430, computer system 1400 may communicate with other devices, such as mobile devices and enterprise systems, connected to network 1430. Communications to and from computer system 1400 may be sent through network interface 1420. For example, network interface 1420 may receive incoming communications (such as requests or responses from other devices) in the form of one or more packets (such as Internet Protocol (IP) packets) from network 1430, and computer system 1400 may store the incoming communications in memory 1403 for processing. Computer system 1400 may similarly store outgoing communications (such as requests or responses to other devices) in the form of one or more packets in memory 1403 and communicated to network 1430 from network interface 1420. Processor(s) 1401 may access these communication packets stored in memory 1403 for processing.

Examples of the network interface 1420 include, but are not limited to, a network interface card, a modem, and any combination thereof. Examples of a network 1430 or network segment 1430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1430, may employ a wired and/or a wireless mode of communication. In general, any network topology may be used.

Information and data can be displayed through a display 1432. Examples of a display 1432 include, but are not limited to, a liquid crystal display (LCD), an organic liquid crystal display (OLED), a cathode ray tube (CRT), a plasma display, and any combinations thereof. The display 1432 can interface to the processor(s) 1401, memory 1403, and fixed storage 1408, as well as other devices, such as input device(s) 1433, via the bus 1440. The display 1432 is linked to the bus 1440 via a video interface 1422, and transport of data between the display 1432 and the bus 1440 can be controlled via the graphics control 1421.

In addition to a display 1432, computer system 1400 may include one or more other peripheral output devices 1434 including, but not limited to, an audio speaker, a printer, a check or receipt printer, and any combinations thereof. Such peripheral output devices may be connected to the bus 1440 via an output interface 1424. Examples of an output interface 1424 include, but are not limited to, a serial port, a parallel connection, a USB port, a FIREWIRE port, a THUNDERBOLT port, and any combinations thereof. In some examples, the peripheral output devices may be used to generate reports for the entity, such as, but not limited to, financial reports, feedback reports, inventory reports, etc. For instance, the manager or another staff member at the entity may print a financial report including the amount of revenue for a particular day or time period, tips collected by each server or cook, profit margin, etc. In some other cases, servers may utilize the printer to print food orders that the cook staff may work off of.

In addition, or as an alternative, computer system 1400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 1400 shown in FIG. 14 such as, but not limited to, the network 1430, processor 1401, memory, 1403, etc., may comprise a cloud computing system. In one such system, front-end systems such as input devices 1433 may provide information to back-end platforms such as servers (e.g. computer systems 1400) and storage (e.g., memory 1403). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web server.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for submitting a rental application, the system comprising one or more hardware processors configured by machine-readable instructions to:
provide user identifying information from a user to a rental platform;
provide user income information from the user to the rental platform;
provide user background information from the user to the rental platform;
pay an application fee on the rental platform;
enable a user to proactively approve a credit and background check on the rental platform prior to a landlord requesting the approval;
send information related to the credit and background check from the rental platform to a consumer credit reporting agency;
receive, at the rental platform, a plurality of questions from the consumer credit reporting agency;
send the plurality of questions from the rental platform to the user;
provide a plurality of answers from the user to the rental platform in response to the plurality of questions;
send the plurality of answers from the rental platform to the consumer credit reporting agency;
inform the user the application is complete;
receive, at the rental platform, a response from the consumer credit reporting agency, wherein the response comprises information related to the user's credit history; and
enable the landlord to access the information related to the user's credit history.

2. The system of claim 1, wherein the one or more hardware processors are further configured by machine-readable instructions to:
provide landlord-identifying information from the landlord to the rental platform and from the rental platform to the consumer credit reporting agency prior to providing user identifying information from the user to the rental platform; and
have the landlord request a credit and background report for the user prior to receiving, at the rental platform, a response from the consumer credit reporting agency.

3. The system of claim 1, wherein:
the user's credit history comprises a user's credit score;
the rental application comprises an application to lease real property; and
the landlord comprises an owner of the real property.

4. The system of claim 2, wherein the one or more hardware processors are further configured by machine-readable instructions to:
provide landlord pre-approval of a signed rental agreement when the user's credit history meets a predetermined level, after providing the landlord identifying information from the landlord to the rental platform;
send the signed rental agreement to the user when the user's credit history meets the predetermined level, after receiving at the rental platform the response from the consumer credit reporting agency;
enable the user to digitally sign the rental agreement; and
send the digitally signed rental agreement to the rental platform.

5. The system of claim 4, wherein pre-approval of the signed rental agreement is further dependent upon predictive analytic data based on recent history of the user.

6. The system of claim 1, wherein the one or more hardware processors are further configured by machine-readable instructions to generate the plurality of questions at the consumer credit reporting agency;
wherein at least some information related to the credit and background check is used to generate the questions; and
wherein the plurality of questions relates to verifying an identification of the user and reducing fraudulent application submissions.

7. The system of claim 1, wherein the user identifying information comprises at least one of a current physical address, a past physical address, a name, an email address, and a phone number; income information comprises at least one of, a name and location of a current employer, a job title, an income amount received from the current employer, a job start date, contact information for the current employer, an income amount received from an additional income source, and a current financial institution name; and background information comprises at least one of information related to an eviction, information related to any criminal charges, and information related to a bankruptcy.

8. A method of submitting a rental application, comprising:
providing user identifying information from a user to a rental platform;
providing user income information from the user to the rental platform;
providing user background information from the user to the rental platform;
paying an application fee on the rental platform;
enabling a user to proactively approve a credit and background check r on the rental platform prior to a landlord requesting the approval;
sending information related to the credit and background check from the rental platform to a consumer credit reporting agency;
receiving at the rental platform a plurality of questions from the consumer credit reporting agency;
sending the plurality of questions from the rental platform to the user;
providing a plurality of answers in response to the plurality of questions from the user to the rental platform;
sending the plurality of answers from the rental platform to the consumer credit reporting agency;
informing, the user, the application is complete;
receiving, at the rental platform, a response from the consumer credit reporting agency, wherein the response comprises information related to the user's credit history; and
enabling the landlord to access the information related to the user's credit history.

9. The method of claim 8, further comprising:
providing landlord-identifying information from the landlord to the rental platform and from the rental platform to the consumer credit reporting agency prior to providing user-identifying information from the user to the rental platform; and
having the landlord request a credit and background report for the user prior to receiving, at the rental platform, a response from the consumer credit reporting agency.

10. The method of claim 8, wherein:
the user's credit history comprises a user's credit score;
the rental application comprises an application to lease real property; and
the landlord comprises an owner of the real property.

11. The method of claim 9, further comprising:
providing landlord pre-approve a signed rental agreement when the user's credit history meets a predetermined level after providing landlord identifying information from the landlord to the rental platform;
sending the signed rental agreement to the user when the user's credit history meets the predetermined level, after receiving at the rental platform the response from the consumer credit reporting agency;
enabling the user to digitally sign the rental agreement; and
sending the digitally signed rental agreement to the rental platform.

12. The method of claim 11, wherein pre-approval of the signed rental agreement is further dependent upon predictive analytic data based on recent history of the user.

13. The method of claim 8, further comprising generating the plurality of questions at the consumer credit reporting agency;
wherein at least some information related to the credit and background check is used to generate the questions; and
wherein the plurality of questions relates to verifying an identification of the user and reducing fraudulent application submissions.

14. The method of claim 8, wherein:
user identifying information comprises at least one of a current physical address, a past physical address, a name, an email address, and a phone number; income information comprises at least one of, a name and location of a current employer, a job title, an income amount received from the current employer, a job start date, contact information for the current employer, an income amount received from an additional income source, and a current financial institution name; and background information comprises at least one of information related to an eviction, information related to any criminal charges, and information related to a bankruptcy.

15. A non-transient computer-readable storage medium having instructions embodied thereon, the instructions being executable by one or more processors to perform a method for submitting a rental application, the method comprising:
providing user identifying information from a user to a rental platform;
providing user income information from the user to the rental platform;
providing user background information from the user to the rental platform;
paying an application fee on the rental platform;
enabling a user to proactively approve a credit and background on the rental platform prior to a landlord requesting the approval;
sending information related to the credit and background check from the rental platform to a consumer credit reporting agency;
receiving, at the rental platform, a plurality of questions from the consumer credit reporting agency;
sending the plurality of questions from the rental platform to the user;
providing a plurality of answers in response to the plurality of questions from the user to the rental platform;
sending the plurality of answers from the rental platform to the consumer credit reporting agency;
informing, the user, the application is complete;
receiving, at the rental platform, a response from the consumer credit reporting agency, wherein the response comprises information related to the user's credit history; and
enabling the landlord to access the information related to the user's credit history.

16. The computer-readable storage medium of claim 15, wherein the method further comprises:
providing landlord-identifying information from the landlord to the rental platform and from the rental platform to the consumer credit reporting agency prior to providing user-identifying information from the user to the rental platform; and
having the landlord request a credit and background report for the user prior to receiving, at the rental platform, a response from the consumer credit reporting agency.

17. The computer-readable storage medium of claim 15, wherein:
the user's credit history comprises a user's credit score;
the rental application comprises an application to lease real property; and
the landlord comprises an owner of the real property.

18. The computer-readable storage medium of claim 16, wherein the method further comprises:
providing landlord pre-approval of a signed rental agreement when the user's credit history meets a predetermined level after providing the landlord identifying information from the landlord to the rental platform;
sending the signed rental agreement to the user when the user's credit history meets the predetermined level, after receiving at the rental platform the response from the consumer credit reporting agency;
enabling the user to digitally sign the rental agreement; and
sending the digitally signed rental agreement to the rental platform.

19. The computer-readable storage medium of claim 18, wherein pre-approval of the signed rental agreement is further dependent upon predictive analytic data based on recent history of the user.

20. The computer-readable storage medium of claim 15, wherein the method further comprises generating the plurality of questions at the consumer credit reporting agency;
wherein at least some information related to the credit and background check is used to generate the questions; and
wherein the plurality of questions relates to verifying an identification of the user and reducing fraudulent application submissions.
